(19) United States
(12) Patent Application Publication
(10) Pub. No.: US 2025/0038814 A1
(43) Pub. Date: Jan. 30, 2025

(54) Resource Configuration Method and Device

(71) Applicant: VIVO MOBILE COMMUNICATION CO., LTD., Dongguan (CN)

(72) Inventors: Xiaohang Chen, Dongguan (CN); Xueming Pan, Dongguan (CN)

(21) Appl. No.: 18/914,563

(22) Filed: Oct. 14, 2024

Related U.S. Application Data
(63) Continuation of application No. PCT/CN2023/088042, filed on Apr. 13, 2023.

(30) Foreign Application Priority Data
Apr. 15, 2022 (CN) 202210400214.2

(51) Int. Cl. H04B 7/06; H04L 5/00; H04W 24/10

(52) U.S. Cl. CPC H04B 7/0626; H04L 5/0005; H04W 24/10

(57) ABSTRACT

A resource configuration method includes receiving, by a terminal, one or more pieces of CSI-RS resource configuration information sent by a network side device; and performing, by the terminal, channel measurement and report or interference measurement and report on a target resource based on the one or more pieces of CSI-RS resource configuration information, where the CSI-RS resource configuration information is used to configure at least one first CSI-RS resource configuration; at least one second CSI-RS resource configuration; or at least one third CSI-RS resource configuration; the first CSI-RS resource configuration is used for a first resource; the second CSI-RS resource configuration is used for a second resource; and the third CSI-RS resource configuration is used for a third resource.

### CROSS-REFERENCE TO RELATED APPLICATIONS

This application is a Bypass Continuation Application of International Patent Application No. PCT/CN2023/088042 filed Apr. 13, 2023, and claims priority to Chinese Patent Application No. 202210400214.2 filed Apr. 15, 2022, the disclosures of which are hereby incorporated by reference in their entireties.

### BACKGROUND OF THE INVENTION

### Field of the Invention

This application pertains to the field of communication technologies, and in particular, to a resource configuration method and a device.

### Description of Related Art

When a network operates in a full-duplex mode, a network side device may send a reference signal to user equipment (UE), and the UE may measure a channel state between a base station and the UE based on a reference signal sent by the network side device.

However, the UE can usually measure only a magnitude of interference between a channel and a cell, but cannot measure interference in other scenarios (for example, interference caused by other UEs in a co-channel or an adjacent channel in cells with different transmission directions).

### SUMMARY OF THE INVENTION

According to a first aspect, a resource configuration method is provided, and the method includes: receiving, by a terminal, one or more pieces of CSI reference signal (CSI-RS) resource configuration information sent by a network side device; and performing, by the terminal, channel measurement and report or interference measurement and report on a target resource based on the one or more pieces of CSI-RS resource configuration information, where the CSI-RS resource configuration information is used to configure at least one of the following: at least one first CSI-RS resource configuration; at least one second CSI-RS resource configuration; or at least one third CSI-RS resource configuration; the first CSI-RS resource configuration is used for a first resource; the second CSI-RS resource configuration is used for a second resource; and the third CSI-RS resource configuration is used for a third resource.

According to a second aspect, a resource configuration apparatus is provided, and the apparatus includes: a receiving module, configured to receive one or more pieces of CSI-RS resource configuration information sent by a network side device; and an execution module, configured to perform channel measurement and report or interference measurement and report on a target resource based on the one or more pieces of CSI-RS resource configuration information received by the receiving module, where the CSI-RS resource configuration information is used to configure at least one of the following: at least one first CSI-RS resource configuration; at least one second CSI-RS resource configuration; or at least one third CSI-RS resource configuration; the first CSI-RS resource configuration is used for a first resource; the second CSI-RS resource configuration is used for a second resource; and the third CSI-RS resource configuration is used for a third resource.

According to a third aspect, a resource configuration method is provided, and the method includes: sending, by a network side device, one or more pieces of CSI-RS resource configuration information to a terminal, where the CSI-RS resource configuration information is used to configure at least one of the following: at least one first CSI-RS resource configuration; at least one second CSI-RS resource configuration; or at least one third CSI-RS resource configuration; the first CSI-RS resource configuration is used for a first resource; the second CSI-RS resource configuration is used for a second resource; and the third CSI-RS resource configuration is used for a third resource.

According to a fourth aspect, a resource configuration apparatus is provided, and the apparatus includes: a sending module, configured to send one or more pieces of CSI-RS resource configuration information to a terminal, where the CSI-RS resource configuration information is used to configure at least one of the following: at least one first CSI-RS resource configuration; at least one second CSI-RS resource configuration; or at least one third CSI-RS resource configuration; the first CSI-RS resource configuration is used for a first resource; the second CSI-RS resource configuration is used for a second resource; and the third CSI-RS resource configuration is used for a third resource.

According to a fifth aspect, a terminal is provided. The terminal includes a processor and a memory, the memory stores a program or an instruction executable on the processor, and when the program or the instruction is executed by the processor, steps of the method according to the first aspect are implemented.

According to a sixth aspect, a terminal is provided, including a processor and a communication interface, where the communication interface is configured to receive one or more pieces of CSI-RS resource configuration information sent by a network side device; and the processor is configured to perform channel measurement and report or interference measurement and report on a target resource based on the one or more pieces of CSI-RS resource configuration information received by the communication interface, where the CSI-RS resource configuration information is used to configure at least one of the following: at least one first CSI-RS resource configuration; at least one second CSI-RS resource configuration; or at least one third CSI-RS resource configuration; the first CSI-RS resource configuration is used for a first resource; the second CSI-RS resource configuration is used for a second resource; and the third CSI-RS resource configuration is used for a third resource.

According to a seventh aspect, a network side device is provided. The network side device includes a processor and a memory, the memory stores a program or an instruction executable on the processor, and when the program or the instruction is executed by the processor, steps of the method according to the third aspect are implemented.

According to an eighth aspect, a network side device is provided, including a processor and a communication interface, where the communication interface is configured to send one or more pieces of CSI-RS resource configuration information to a terminal, where the CSI-RS resource configuration information is used to configure at least one of the following: at least one first CSI-RS resource configuration; at least one second CSI-RS resource configuration; or at least one third CSI-RS resource configuration; the first CSI-RS resource configuration is used for a first resource; the second CSI-RS resource configuration is used for a second resource; and the third CSI-RS resource configuration is used for a third resource.

According to a ninth aspect, a communication system is provided, including a terminal and a network side device. The terminal may be configured to perform the steps of the method according to the first aspect, and the network side device may be configured to perform the steps of the method according to the third aspect.

According to a tenth aspect, a non-transitory readable storage medium is provided. The non-transitory readable storage medium stores a program or an instruction, and when the program or the instruction is executed by a processor, the steps of the method according to the first aspect or the steps of the method according to the third aspect are implemented.

According to an eleventh aspect, a chip is provided. The chip includes a processor and a communication interface, the communication interface is coupled to the processor, and the processor is configured to run a program or an instruction to implement the method according to the first aspect or the third aspect.

According to a twelfth aspect, a computer program/program product is provided, the computer program/program product is stored in a non-transitory storage medium, and the computer program/program product is executed by at least one processor to implement the method according to the first aspect or the third aspect.

### BRIEF DESCRIPTION OF THE DRAWINGS

FIG. 1 is a system architecture diagram of a wireless communication system according to an embodiment of this application;

FIG. 2 is a first schematic diagram of a resource relationship according to an embodiment of this application;

FIG. 3 is a second schematic diagram of a resource relationship according to an embodiment of this application;

FIG. 4 is a third schematic diagram of a resource relationship according to an embodiment of this application;

FIG. 5 is a fourth schematic diagram of a resource relationship according to an embodiment of this application;

FIG. 6 is a method flowchart of a resource configuration method according to an embodiment of this application;

FIG. 7 is a fifth schematic diagram of a resource relationship according to an embodiment of this application;

FIG. 8 is a sixth schematic diagram of a resource relationship according to an embodiment of this application;

FIG. 9 is a first schematic diagram of a structure of a resource configuration apparatus according to an embodiment of this application;

FIG. 10 is a second schematic diagram of a structure of a resource configuration apparatus according to an embodiment of this application;

FIG. 11 is a schematic diagram of a structure of a communication device according to an embodiment of this application;

FIG. 12 is a schematic diagram of a hardware structure of a terminal according to an embodiment of this application; and

FIG. 13 is a schematic diagram of a hardware structure of a network side device according to an embodiment of this application.

### DESCRIPTION OF THE INVENTION

The following clearly describes the technical solutions in the embodiments of this application with reference to the accompanying drawings in the embodiments of this application. Apparently, the described embodiments are some but not all of the embodiments of this application. All other embodiments obtained by a person of ordinary skill in the art based on the embodiments of this application shall fall within the protection scope of this application.

The terms “first”, “second”, and the like in this specification and claims of this application are used to distinguish between similar objects instead of describing an order or sequence. It should be understood that, the terms used in such a way are interchangeable in proper circumstances, so that the embodiments of this application can be implemented in an order other than the order illustrated or described herein. Objects classified by “first” and “second” are usually of a same type, and the number of objects is not limited. For example, there may be one or more first objects. In addition, in the description and the claims, “and/or” represents at least one of connected objects, and a character “/” generally represents an “or” relationship between associated objects.

It should be noted that technologies described in the embodiments of this application are not limited to a Long Term Evolution (LTE)/LTE-Advanced (LTE-A) system, and may further be applied to other wireless communication systems such as Code Division Multiple Access (CDMA), Time Division Multiple Access (TDMA), Frequency Division Multiple Access (FDMA), Orthogonal Frequency Division Multiple Access (OFDMA), single-carrier frequency division multiple access (SC-FDMA), and other systems. The terms “system” and “network” in the embodiments of this application may be used interchangeably. The technologies described can be applied to both the systems and the radio technologies mentioned above as well as to other systems and radio technologies. A new radio (NR) system is described in the following description for illustrative purposes, and the NR terminology is used in most of the following description, although these technologies can also be applied to applications other than the NR system application, such as the 6-th generation (6G) communication system.

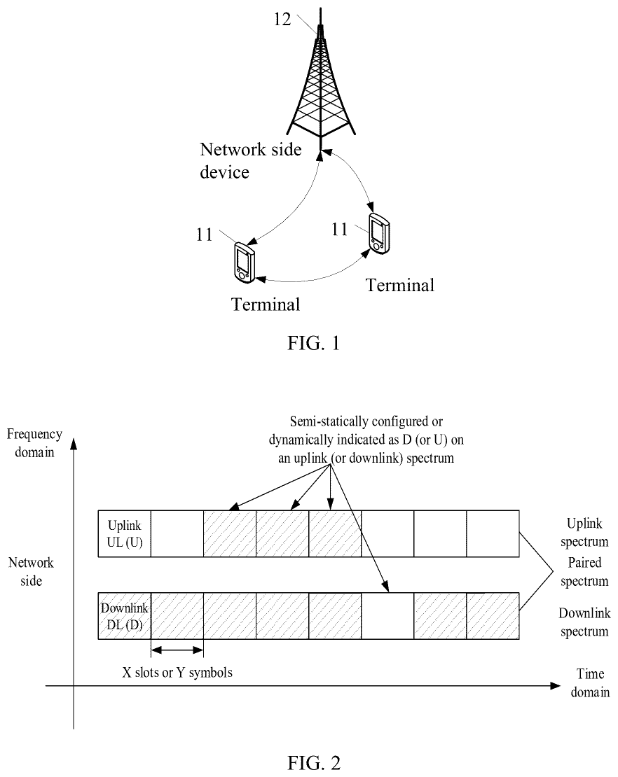

FIG. 1 is a block diagram of a wireless communication system to which the embodiments of this application may be applied. The wireless communication system includes terminals 11 and a network side device 12. The terminal 11 may be a terminal side device such as a mobile phone, a tablet personal computer, a laptop computer or a notebook computer, a personal digital assistant (PDA), a palmtop computer, a netbook, an ultra-mobile personal computer (UMPC), a mobile Internet device (MID), an augmented reality (AR)/virtual reality (VR) device, a robot, a wearable device, vehicle user equipment (VUE), pedestrian user equipment (PUE), smart household (household devices with wireless communication functions, such as a refrigerator, a television, a washing machine, or furniture), a game console, a personal computer (PC), a teller machine, or a self-service machine, and the wearable device includes a smart watch, a smart band, smart earphones, smart glasses, smart jewelry (a smart bracelet, a smart hand chain, a smart ring, a smart necklace, a smart bangle, a smart anklet, or the like), a smart wristband, smart clothes, and the like. It should be noted that a type of the terminal 11 is not limited in the embodiments of this application. The network side device 12 may include an access network device or a core network device. The access network device 12 may also be referred to as a radio access network device, a radio access network (RAN), a radio access network function, or a radio access network unit. The access network device 12 may include a base station, a WLAN access node, a Wi-Fi node, or the like. The base station may be referred to as a NodeB, an evolved NodeB (eNB), an access point, a base transceiver station (BTS), a radio base station, a radio transceiver, a basic service set (BSS), an extended service set (ESS), a home NodeB, a home evolved NodeB, a transmitting receiving point (TRP), or another appropriate term in the art. As long as a same technical effect is achieved, the base station is not limited to a specified technical term. It should be noted that, in the embodiments of this application, only a base station in an NR system is used as an example, but a type of the base station is not limited.

The following describes technical terms involved in the technical solution provided in the embodiments of this application.

### (1) Full Duplex/Flexible Duplex/Duplex Evolution

At present, a spectrum standard deployed by a network is fixed, and there are mainly the following two types.

Time division duplexing (TDD): a transmitter and a receiver share a common radio-frequency frequency point, and an uplink and a downlink use different slots for communication.

Frequency division duplexing (FDD): a transmitter and a receiver use different radio-frequency frequency points for communication.

It should be noted that the above two standards have advantages and disadvantages. Because an uplink and a downlink of a TDD system are distinguished by time, there is no need to require a frequency band with symmetrical bandwidth. Therefore, TDD may use fragmented frequency bands, and is suitable for an obviously uplink-downlink asymmetric service. However, it is not conducive to a latency-sensitive service, and because a transmission time of TDD is only about half that of FDD, coverage or a throughput is limited; and when an FDD system supports an asymmetric service, a spectrum utilization rate may be greatly reduced. Therefore, future mobile communication requires more flexibility in the use of spectrum. Flexible/full duplex/duplex evolution on a network side is considered as a potential technology, which may improve a spectrum utilization rate, improve uplink coverage, and reduce a latency of a latency-sensitive service. However, on a terminal side, due to complexity of implementation, only a half-duplex operation can be supported on the terminal side.

Features of Rel-18 network side flexible duplex/full duplex and user/terminal side half-duplex operations.

As shown in FIG. 2, for a symmetric spectrum of FDD, an uplink or downlink spectrum of FDD may be semi-statically configured or dynamically indicated as downlink or uplink transmission on some slots/symbols.

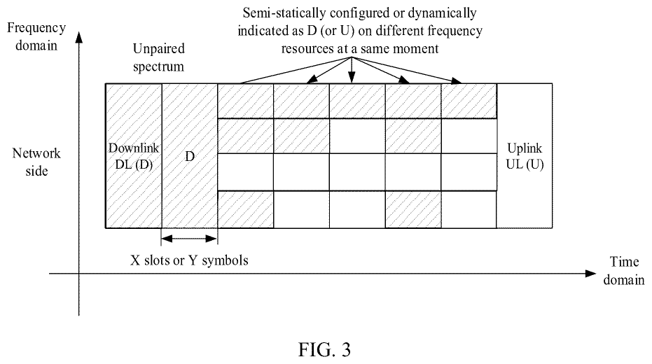

As shown in FIG. 3, for an asymmetric spectrum of TDD, different frequency domain resources of TDD on some slots/symbols may be semi-statically configured or dynamically indicated as having both uplink slots/symbols and downlink slots/symbols.

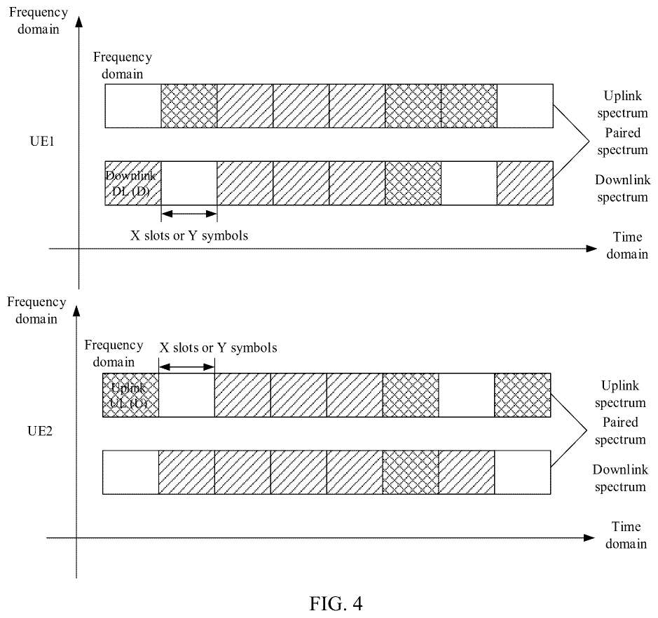

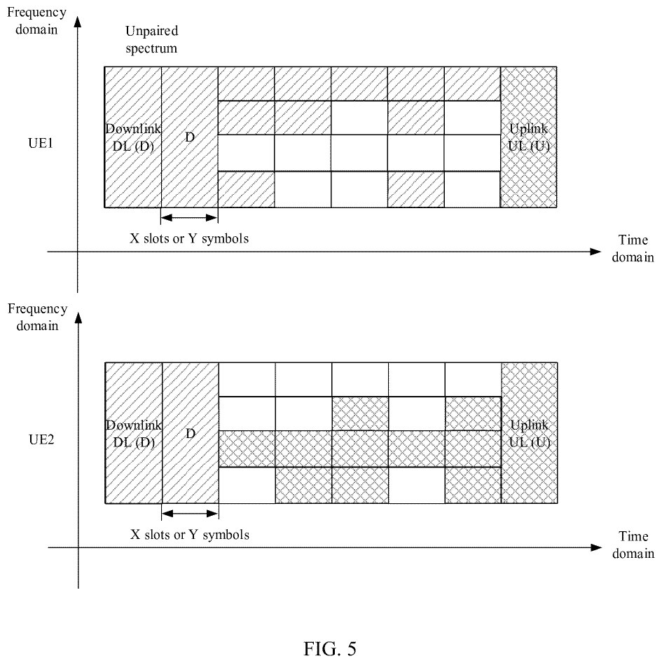

As shown in FIG. 4 and FIG. 5, for a half-duplex terminal, only uplink sending or downlink reception can be performed at the same time, that is, the terminal cannot receive and send a signal at a same moment. It should be noted that FIG. 4 corresponds to FIG. 2 on the network side, and FIG. 5 corresponds to FIG. 3 on the network side.

It should be noted that no matter whether it is a symmetric spectrum or an asymmetric spectrum, it is required to introduce new signaling or enhance existing signaling, and inform the terminal of a transmission/reception direction in time, that is, which slot/symbol, and in frequency, that is, which subband, sub-carrier, resource block (RB), RB set, or RB group, that is, uplink (U), downlink (D), or flexible (F) (it may also be referred to as unknown, which mainly refers to an uncertain direction, and may be used as both uplink and downlink transmission direction configurations).

### (2) Transmission Format

To realize flexible network deployment, a transmission direction of each symbol in one slot is configured in the NR system in a manner of slot format. There are three definitions for transmission direction of slot in NR: downlink (DL), uplink (UL), and flexible. When the network is configured with a slot or a symbol of DL or UL, a transmission direction at this moment is clear; and when the network is configured with a slot or a symbol of flexible, a transmission direction at this moment is to be determined. The network may modify the transmission direction of the slot or the symbol of flexible through dynamic signaling, for example, a dynamic SFI (slot format indicator).

For example, one slot may include an OFDM symbol of downlink, uplink, and flexible; and the flexible symbol may be rewritten as a downlink or uplink symbol.

For example, the SFI may indicate a format of one or more slots. The SFI is sent in a GC-PDCCH. In an example, the SFI may flexibly change a format of slot according to a requirement, to satisfy a service transmission requirement. In an example, UE decides whether to monitor a PDCCH based on an indication of the SFI.

For example, a base station may semi-statically configure one or more cell-specific slot formats for UE through high-level parameters UL-DL-configuration-common and/or UL-DL-configuration-common-Set2. Alternatively, the base station may also semi-statically configure one or more UE-specific slot formats through a high-level parameter UL-DL-configuration-dedicated. Alternatively, the base station may rewrite a flexible symbol or slot in a semi-static configuration through an SFI carried in a GC-PDCCH.

For example, UE-specific transmission includes a PDSCH, a physical uplink shared channel (PUSCH), an A/N feedback of a physical downlink shared channel (PDSCH), aperiodic measurement triggered by downlink control information (DCI), and the like.

For example, a transmission direction implicitly indicated by a UE-specific RRC configuration is collectively referred to as measurement, including:
(1) periodic or semi-persistent CSI-RS measurement configured by UE-specific radio resource control (RRC) signaling, periodic CSI reporting, and uplink and downlink transmission directions implicitly indicated by a periodic or semi-persistent SRS;
(2) a physical random access channel (PRACH) resource configured by UE-specific RRC, and type1 and type2 grant-free uplink transmission; and
(3) for the type2 grant-free uplink transmission, only transmission on a 1st activated resource is regarded as UE-specific data.

The technical solutions provided in the embodiments of this application may be used for FDD and TDD spectra, as well as authorized frequency bands and unauthorized frequency bands, and may also be used in single-carrier and multi-carrier scenarios.

A resource configuration method and apparatus, a device, and a medium provided in the embodiments of this application are described below in detail with reference to the accompanying drawings by using some embodiments and application scenarios thereof.

When a network operates in a full-duplex mode, a network side device may send a reference signal to user equipment (UE), and the UE may measure a channel state between a base station and the UE based on a reference signal sent by the network side device.

However, based on the reference signal, the UE can usually measure only a magnitude of interference between a channel and a cell, but cannot measure interference caused by other UEs in a co-channel or an adjacent channel in cells with different transmission directions. For example, frequency domain resources of UE 1 and UE2 may or may not overlap when a base station simultaneously sends downlink data to UE 1 and receives uplink data from UE2 at time t. In this case, when receiving downlink transmission, UE 1 may be affected by uplink transmission sent by UE2.

In the resource configuration method and apparatus, a device, and a medium provided in the embodiments of this application, a network side device configures one or more pieces of CSI-RS resource configuration information for a terminal, so that the terminal may perform channel measurement and report or interference measurement and report on a target resource based on the one or more pieces of CSI-RS resource configuration information. Because the one or more pieces of CSI-RS resource configuration information are used to configure at least three CSI-RS resource configurations, the terminal may use different CSI-RS resource configurations to measure a channel or interference in different situations, thereby effectively improving transmission performance.

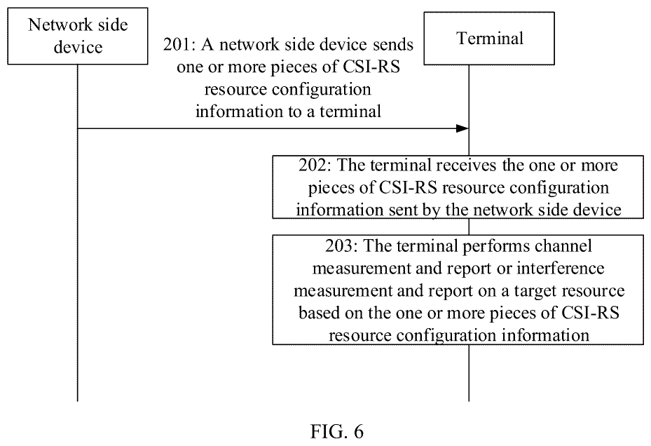

An embodiment of this application provides a resource configuration method. As shown in FIG. 6, the resource configuration method may include the following step 201 to step 203.

Step 201: A network side device sends one or more pieces of CSI-RS resource configuration information to a terminal.

Step 202: The terminal receives the one or more pieces of CSI-RS resource configuration information sent by the network side device.

Step 203: The terminal performs channel measurement and report or interference measurement and report on a target resource based on the one or more pieces of CSI-RS resource configuration information.

In this embodiment of this application, the one or more pieces of CSI-RS resource configuration information is used to configure at least one of the following:
at least one first CSI-RS resource configuration;
at least one second CSI-RS resource configuration; or
at least one third CSI-RS resource configuration.

The first CSI-RS resource configuration is used for a first resource; the second CSI-RS resource configuration is used for a second resource; and the third CSI-RS resource configuration is used for a third resource.

It should be noted that the CSI-RS resource configuration information may also be configured for CSI-RS reporting.

In this embodiment of this application, each CSI-RS resource configuration includes at least one CSI-RS resource for channel measurement or interference measurement.

In this embodiment of this application, the one or more pieces of CSI-RS resource configuration information includes a plurality of sets of CSI-RS resources, which are respectively used for channel measurement or interference measurement in different situations. In other words, a plurality of CSI-RS resource configurations configured by the one or more pieces of CSI-RS resource configuration information are respectively used for channel measurement or interference measurement in different situations.

Optionally, in this embodiment of this application, the first CSI-RS resource configuration is used to configure a first CSI-RS. The first CSI-RS resource configuration is used to configure a second CSI-RS. The third CSI-RS resource configuration is used to configure a third CSI-RS.

In some possible embodiments, the first CSI-RS resource configuration is used to configure a Type-1 reference signal (for example, Type-1 CSI-RS/CSI interference measurement (CSI-IM)), for channel measurement and report or interference measurement and report on a first resource. The second CSI-RS resource configuration is used to configure a Type-2 reference signal (for example, Type-2 CSI-RS/CSI-IM), for channel measurement and report or interference measurement and report on a second resource. The third CSI-RS resource configuration is used to configure a Type-3 reference signal (for example, Type-3 CSI-RS/CSI-IM), for channel measurement and report or interference measurement and report on a third resource.

In some possible embodiments, the Type-2 CSI-RS may be a non-zero-power CSI-RS (NZP-CSI-RS).

In some possible embodiments, the Type-3 CSI-RS may be a CSI-RS or a ZP-CSI-RS, and the network side device does not send a CSI-RS on this resource, but the terminal needs to perform rate matching for downlink transmission based on the CSI-RS resource.

In some possible embodiments, resources of the Type-1 reference signal/Type-2 reference signal/Type-3 reference signal may overlap or not.

In some possible embodiments, the Type-1 reference signal/Type-2 reference signal/Type-3 reference signal may correspond to the same or different CSI reporting types.

In some possible embodiments, when the terminal performs CSI measurement, smoothing processing may be performed on the Type-1 reference signal/Type-2 reference signal/Type-3 reference signal, for example, smoothing processing is performed only on measurement of the same reference signal type.

In some possible embodiments, if reference signals configured by using the CSI-RS resource configuration include a plurality of types of reference signals (for example, the Type-1 reference signal/Type-2 reference signal/Type-3 reference signal), different reference signals may be used for channel measurement or interference measurement. For example, different Type-1 reference signals/Type-2 reference signals/Type-3 reference signals are used for channel measurement, or different Type-1 reference signals/Type-2 reference signals/Type-3 reference signals are used for interference measurement.

Optionally, in this embodiment of this application, the first resource, the second resource, or the third resource may be a time-frequency domain resource configured by a network or a time-frequency domain resource indicated by a network. Alternatively, the first resource, the second resource, or the third resource may be a resource configured by a network for specific downlink transmission (a PDCCH/PDSCH/CSI-RS, and the like) or a resource indicated by a network for specific downlink transmission (a physical downlink control channel (PDCCH)/PDSCH/CSI-RS, and the like).

Optionally, in this embodiment of this application, a transmission format of the first resource is DL.

Optionally, in this embodiment of this application, a transmission format of the second resource is DL.

Optionally, in this embodiment of this application, a transmission format of the third resource is DL.

It should be noted that, the transmission format of the resource includes a frequency domain transmission format or a time domain transmission format. The frequency domain transmission format may be indicated by a frequency domain format indication, and the time domain transmission format may be indicated by a time domain format indication.

Optionally, in this embodiment of this application, the first resource has no co-channel interference or adjacent channel interference.

Optionally, in this embodiment of this application, the first resource meets any one of the following that:
(1) a frequency domain resource unit of the first resource does not overlap with any frequency domain resource unit in a transmission format of uplink or flexible;
(2) a frequency domain interval between a frequency domain resource unit of the first resource and a frequency domain resource unit in a transmission format of uplink or flexible is greater than or equal to N first frequency domain resource units; and
(3) a frequency domain interval between a center frequency of the first resource and a center frequency of a frequency domain resource unit in a transmission format of uplink or flexible is greater than or equal to M second frequency domain resource units, where
N and M are positive integers.

It should be noted that N and M may be configured by a network or predefined.

It should be noted that N and M are related to a size and/or a quantity of frequency domain resource units of the first resource. For example, the larger or more the frequency domain resource units are, the larger the value of N or Mis; or vice versa.

It should be noted that N and M are related to a size and/or a quantity of frequency domain resource units of UL or flexible. For example, the larger or more the frequency domain resource units of UL or flexible are, the larger the value of N or M is; or vice versa.

In some possible embodiments, the frequency domain resource unit includes at least one of the following:
frequency domain subband;
resource block (RB); or
bandwidth part (BWP).

In some possible embodiments, the first frequency domain resource unit includes at least one of the following: frequency domain subband; RB; or BWP.

In some possible embodiments, the second frequency domain resource unit includes at least one of the following: frequency domain subband; RB; or BWP.

It should be noted that the first frequency domain resource unit or the second frequency domain resource unit may be the same as or different from the frequency domain resource unit of the first resource.

In some possible embodiments, that the frequency domain resource unit is a frequency domain subband is used as an example, and the first resource meets at least one of the following.

Opt-1: A frequency domain subband of the first resource does not overlap with a frequency domain subband in a transmission format of UL or flexible.

For example, the transmission format of the first resource is DL, the frequency domain format indication (for example, FFI) indicates that frequency domain subband 2 in a transmission format of flexible is UL, and frequency domain subband 1 of the first resource does not overlap with frequency domain subband 2 in a transmission format of flexible.

Opt-2: A frequency domain interval between the first resource and the frequency domain subband in a transmission format of UL or flexible is greater than or equal to N frequency domain resource units.

For example, the transmission format of the first resource is DL. If frequency domain subband 1 of the first resource does not overlap with frequency domain subband 2 in a transmission format of flexible, and a dynamic frequency domain format indicates that a transmission format of frequency domain subband 2 of flexible is UL, a frequency domain interval between frequency domain subband 1 and frequency domain subband 2 needs to be greater than or equal to N first frequency domain resource units.

Opt-3: The transmission format of the first resource is DL, a center frequency of frequency domain subband 1 of the first resource is f0, a center frequency of k (k is a positive integer) continuous frequency domain subbands 2 in a transmission format of UL or flexible is f1, and a frequency domain interval between f0 and f1 needs to be greater than or equal to M second frequency domain resource units.

In some possible embodiments, the terminal may determine, based on the frequency domain format indication, whether the target resource is the first resource.

For example, as for (1), if the frequency domain format indication indicates that frequency domain subband 2 is UL, a transmission format of resource 1 is DL, and frequency domain subband 1 of resource 1 does not overlap with frequency domain subband 2 in a transmission format of flexible, then resource 1 is determined as the first resource.

For example, as for (2), if frequency domain subband 1 of resource 1 does not overlap with frequency domain subband 2 in a transmission format of flexible, the frequency domain format indication indicates that a transmission format of frequency domain subband 2 of flexible is UL, and a frequency domain interval between frequency domain subband 1 and frequency domain subband 2 is greater than or equal to N first frequency domain resource units, resource 1 is determined as the first resource.

For example, as for (3), if frequency domain subband 1 of resource 1 does not overlap with frequency domain subband 2 in a transmission format of flexible, the frequency domain format indication indicates that a transmission format of frequency domain subband 2 of flexible is UL, and a frequency domain interval between a center frequency of frequency domain subband 1 and a center frequency of frequency domain subband 2 is greater than or equal to M second frequency domain resource units, resource 1 is determined as the first resource.

For example, the frequency domain format indication may be semi-static or dynamic.

For example, the frequency domain format indication may indicate a transmission format of a frequency domain by explicitly indicating a frequency domain format, or implicitly scheduling uplink or downlink transmission through DCI.

Optionally, in this embodiment of this application, the second resource has co-channel interference or adjacent channel interference.

Optionally, in this embodiment of this application, the second resource meets at least one of the following that:
(1) a frequency domain resource unit of the second resource overlaps with a frequency domain resource unit in a transmission format of uplink or flexible;
(2) a frequency domain resource unit of the second resource does not overlap with a frequency domain resource unit in a transmission format of uplink or flexible, and a frequency domain interval between the frequency domain resource unit of the second resource and a frequency domain resource unit in a transmission format of uplink or flexible is less than or equal to X third frequency domain resource units; or
(3) a frequency domain resource unit of the second resource does not overlap with a frequency domain resource unit in a transmission format of uplink or flexible, and a frequency domain interval between a center frequency of the second resource and a center frequency of a frequency domain resource unit in a transmission format of uplink or flexible is less than or equal to Y fourth frequency domain resource units, where
X and Y are positive integers.

It should be noted that X and Y may be configured by a network or predefined.

It should be noted that X and Y are related to a size and/or a quantity of frequency domain resource units of the second resource. For example, the larger or more the frequency domain resource units are, the larger the value of X or Y is; or vice versa.

It should be noted that X and Y are related to a size and/or a quantity of frequency domain resource units of UL or flexible. For example, the larger or more the frequency domain resource units of UL or flexible are, the larger the value of X or Y is; or vice versa.

It should be noted that a quantity or a granularity of the frequency domain resource unit of the second resource is the same as or different from a quantity or a granularity of a frequency domain resource unit in a frequency transmission format of UL or flexible.

In some possible embodiments, the third frequency domain resource unit includes at least one of the following: frequency domain subband; RB; or BWP.

In some possible embodiments, the fourth frequency domain resource unit includes at least one of the following: frequency domain subband; RB; or BWP.

It should be noted that the third frequency domain resource unit or the fourth frequency domain resource unit may be the same as or different from the frequency domain resource unit of the first resource.

In some possible embodiments, the frequency domain subband is used as an example, and the second resource meets at least one of the following.

Opt-1: A frequency domain subband of the second resource overlaps with a frequency domain subband in a transmission format of UL or flexible.

For example, the transmission format of the second resource is DL, the frequency domain format indication indicates that frequency domain subband 2 in a transmission format of flexible is UL, and frequency domain subband 1 of the second resource overlaps with frequency domain subband 2 in a transmission format of flexible.

Opt-2: A frequency domain subband of the second resource does not overlap with a frequency domain subband in a transmission format of UL or flexible, and a frequency domain interval between the second resource and the frequency domain subband in a transmission format of UL or flexible is less than or equal to X third frequency domain resource units.

For example, the transmission format of the second resource is DL. If frequency domain subband 1 of the second resource does not overlap with frequency domain subband 2 in a transmission format of flexible, and a dynamic frequency domain format indicates that a transmission format of frequency domain subband 2 of flexible is UL, a frequency domain interval between frequency domain subband 1 and frequency domain subband 2 needs to be less than or equal to X third frequency domain resource units.

Opt-3: A frequency domain subband of the second resource does not overlap with a frequency domain subband in a transmission format of UL or flexible, and a frequency domain interval between a center frequency of the second resource and a center frequency of a frequency domain subband in a transmission format of uplink or flexible is less than or equal to Y fourth frequency domain resource units.

For example, the transmission format of the second resource is DL, a center frequency of frequency domain subband 1 of the second resource is f0, a center frequency of k (k is a positive integer) continuous frequency domain subbands 2 in a transmission format of UL or flexible is f1, and if frequency domain subband 1 and frequency domain subband 2 of the second resource do not overlap, a frequency domain interval between f0 and f1 needs to be less than or equal to Y fourth frequency domain resource units.

In some possible embodiments, the terminal may determine, based on the frequency domain format indication, whether the target resource is the second resource.

For example, as for (1), if the frequency domain format indication indicates that frequency domain subband 2 is UL, a transmission format of resource 1 is DL, and frequency domain subband 1 of resource 1 overlaps with frequency domain subband 2 in a transmission format of flexible, then resource 1 is determined as the second resource.

For example, as for (2), if frequency domain subband 1 of resource 1 does not overlap with frequency domain subband 2 in a transmission format of flexible, the frequency domain format indication indicates that a transmission format of frequency domain subband 2 of flexible is UL, and a frequency domain interval between frequency domain subband 1 and frequency domain subband 2 is less than or equal to X third frequency domain resource units, resource 1 is determined as the second resource.

For example, as for (3), if frequency domain subband 1 of resource 1 does not overlap with frequency domain subband 2 in a transmission format of flexible, the frequency domain format indication indicates that a transmission format of frequency domain subband 2 of flexible is UL, and a frequency domain interval between a center frequency of frequency domain subband 1 and a center frequency of frequency domain subband 2 is less than or equal to Y fourth frequency domain resource units, resource 1 is determined as the second resource.

For example, the frequency domain format indication may be semi-static or dynamic.

For example, the frequency domain format indication may indicate a transmission format of a frequency domain by explicitly indicating a frequency domain format, or implicitly scheduling uplink or downlink transmission through DCI.

Optionally, in this embodiment of this application, the third resource meets at least one of the following that:
a frequency domain resource unit of the third resource overlaps with a frequency domain resource unit in a transmission format of uplink or flexible;
a frequency domain resource unit of the third resource does not overlap with a frequency domain resource unit in a transmission format of uplink or flexible, and a frequency domain interval between the frequency domain resource unit of the third resource and a frequency domain resource unit in a transmission format of uplink or flexible is less than or equal to X third frequency domain resource units; or
a frequency domain resource unit of the third resource does not overlap with a frequency domain resource unit in a transmission format of uplink or flexible, and a frequency domain interval between a center frequency of the third resource and a center frequency of a frequency domain resource unit in a transmission format of uplink or flexible is less than or equal to Y fourth frequency domain resource units, where
X and Y are positive integers.

It should be noted that X and Y may be configured by a network or predefined.

It should be noted that X and Y are related to a size and/or a quantity of frequency domain resource units of the third resource. For example, the larger or more the frequency domain resource units are, the larger the value of X or Y is; or vice versa.

It should be noted that X and Y are related to a size and/or a quantity of frequency domain resource units of UL or flexible. For example, the larger or more the frequency domain resource units of UL or flexible are, the larger the value of X or Y is; or vice versa.

It should be noted that a quantity or a granularity of the frequency domain resource unit of the third resource is the same as or different from a quantity or a granularity of a frequency domain resource unit in a frequency transmission format of UL or flexible.

As for the situation that the third resource has co-channel interference or adjacent channel interference.

In some possible embodiments, the frequency domain subband is used as an example, and the third resource meets at least one of the following.

Opt-1: A frequency domain subband of the third resource overlaps with a frequency domain subband in a transmission format of UL or flexible.

For example, the transmission format of the third resource is DL, the frequency domain format indication indicates that frequency domain subband 2 in a transmission format of flexible is UL, and frequency domain subband 1 of the third resource overlaps with frequency domain subband 2 in a transmission format of flexible.

Opt-2: A frequency domain subband of the third resource does not overlap with a frequency domain subband in a transmission format of UL or flexible, and a frequency domain interval between the third resource and the frequency domain subband in a transmission format of UL or flexible is less than or equal to X third frequency domain resource units.

For example, the transmission format of the third resource is DL. If frequency domain subband 1 of the third resource does not overlap with frequency domain subband 2 in a transmission format of flexible, and a dynamic frequency domain format indicates that a transmission format of frequency domain subband 2 of flexible is UL, a frequency domain interval between frequency domain subband 1 and frequency domain subband 2 needs to be less than or equal to X third frequency domain resource units.

Opt-3: A frequency domain subband of the third resource does not overlap with a frequency domain subband in a transmission format of UL or flexible, and a frequency domain interval between a center frequency of the third resource and a center frequency of a frequency domain subband in a transmission format of uplink or flexible is less than or equal to Y fourth frequency domain resource units.

For example, the transmission format of the third resource is DL, a center frequency of frequency domain subband 1 of the third resource is f0, a center frequency of k (k is a positive integer) continuous frequency domain subbands 2 in a transmission format of UL or flexible is f1, and if frequency domain subband 1 and frequency domain subband 2 of the third resource do not overlap, a frequency domain interval between f0 and f1 needs to be less than or equal to Y fourth frequency domain resource units.

In some possible embodiments, the terminal may determine, based on the frequency domain format indication, whether the target resource is the third resource.

For example, as for (1), if the frequency domain format indication indicates that frequency domain subband 2 is UL, a transmission format of resource 1 is DL, and frequency domain subband 1 of resource 1 does not overlap with frequency domain subband 2 in a transmission format of flexible, then resource 1 is determined as the third resource.

For example, as for (2), if frequency domain subband 1 of resource 1 does not overlap with frequency domain subband 2 in a transmission format of flexible, the frequency domain format indication indicates that a transmission format of frequency domain subband 2 of flexible is UL, and a frequency domain interval between frequency domain subband 1 and frequency domain subband 2 is less than or equal to X third frequency domain resource units, resource 1 is determined as the third resource.

For example, as for (3), if frequency domain subband 1 of resource 1 does not overlap with frequency domain subband 2 in a transmission format of flexible, the frequency domain format indication indicates that a transmission format of frequency domain subband 2 of flexible is UL, and a frequency domain interval between a center frequency of frequency domain subband 1 and a center frequency of frequency domain subband 2 is less than or equal to Y fourth frequency domain resource units, resource 1 is determined as the third resource.

For example, the frequency domain format indication may be semi-static or dynamic.

For example, the frequency domain format indication may indicate a transmission format of a frequency domain by explicitly indicating a frequency domain format, or implicitly scheduling uplink or downlink transmission through DCI.

Optionally, in this embodiment of this application, the third CSI-RS resource configuration further includes a resource configuration for an uplink reference signal. For example, the uplink reference signal may be an SRS or an uplink DMRS.

Optionally, in this embodiment of this application, the third CSI-RS resource configuration further includes a fourth resource.

In some possible embodiments, the third resource and the fourth resource have co-channel interference or adjacent channel interference.

In some possible embodiments, the fourth resource is a transmission resource of the uplink reference signal.

In some possible embodiments, the uplink reference signal is an uplink reference signal sent by another terminal. It can be understood that the uplink reference signal resource included in the third CSI-RS resource configuration indicates that the terminal measures an uplink reference signal sent by another terminal, and a transmission resource of the uplink reference signal is the fourth resource.

In some possible embodiments, a transmission format of the fourth resource is uplink.

In some possible embodiments, the third resource and the fourth resource may or may not overlap in a frequency domain.

In some possible embodiments, spatial correlation of the uplink reference signal is associated with the first CSI-RS resource configuration or the second CSI-RS resource configuration. In other words, the spatial correlation characteristics of the uplink reference signal are associated with a CSI-RS (for example, Type-2 CSI-RS) configured by the first CSI-RS resource configuration or a CSI-RS (for example, Type-3 CSI-RS) configured by the second CSI-RS resource configuration.

In some possible embodiments, in a case that the third resource and the fourth resource overlap in a frequency domain, a CSI-RS corresponding to the third resource is used to measure co-channel interference; or in a case that the third resource and the fourth resource do not overlap in a frequency domain, a CSI-RS corresponding to the third resource is used to measure adjacent channel interference.

It should be noted that the frequency domain resource unit of UL or flexible mentioned above may be in a current cell or a neighboring cell. That is, the co-channel interference and/or adjacent channel interference may be intra-cell or inter-cell.

Optionally, in this embodiment of this application, for the CSI-RS resource configuration, frequency domain resource units (for example, frequency subbands) corresponding to RS resources included in different CSI-RS resource configurations may be the same or different.

Optionally, in this embodiment of this application, the one or more pieces of CSI-RS resource configuration information are used to configure at least one of the following:
a periodic or semi-persistent CSI-RS resource;
an aperiodic CSI-RS resource;
periodic or semi-persistent CSI reporting; or
aperiodic CSI reporting.

In some possible embodiments, for periodic or semi-persistent CSI reporting:
for example, at time t (the time is configured with sending of a CSI-RS resource), the frequency domain format indication indicates whether there is co-channel interference or adjacent channel interference. If there is co-channel interference or adjacent channel interference at time t, the terminal performs channel or interference measurement based on the second CSI-RS resource configuration, and if there is no co-channel interference or adjacent channel interference at time t, the terminal performs channel or interference measurement based on the first CSI-RS resource configuration.

In some possible embodiments, for periodic/semi-persistent/aperiodic CSI reporting:
for example, the network side device triggers CSI report config 2 (CSI report config 2 includes any one of configurations 1 to 43 in the following table), and the terminal performs channel or interference measurement on different resources based on a corresponding configuration, for example, the first resource has no co-channel interference or adjacent channel interference, and the second resource and the third resource have co-channel interference or adjacent channel interference.

TABLE 1

| | | | | interference | | |
|---|---|---|---|---|---|---|
| | | interference | | measurement | interference | |
| | channel | measurement | channel | w/inter-cell | measurement | |
| | measurement | w/inter-cell | measurement | interference + | w/intra-cell | |
| | w/o intra-cell | interference | w/intra-cell | intra-cell | interference | |
| Number | interference | only | interference | interference | only | Note |
| 1 | Type-1 | | / | | | For L1-RSRP, |
| | CSI-RS | | | | | Type-1 |
| | | | | | | CSI-RS is for |
| | | | | | | channel |
| | | | | | | measurement; |
| | | | | | | For L1-SINR, |
| | | | | | | Type-1 |
| | | | | | | CSI-RS is for |
| | | | | | | channel and |
| | | | | | | interference |
| | | | | | | measurement |
| 2 | Type-1 | Type-1 | | | | For channel |
| | CSI-RS | CSI-RS | | | | measurement, |
| 3 | Type-1 | Type-1 | | | | intra-cell |
| | CSI-RS | CSI-IM | | | | interference is |
| 4 | Type-1 | Type-1 | | | | not considered. |
| | CSI-RS | CSI-IM + | | | | For interference |
| | | Type-1 | | | | measurement, |
| | | CSI-RS | | | | only inter-cell |
| | | | | | | interference |
| | | | | | | is considered |
| 5 | Type-1 | | | Type-2 | | For channel |
| | CSI-RS | | | CSI-RS | | measurement, |
| 6 | Type-1 | | | Type-2 | | intra-cell |
| | CSI-RS | | | CSI-IM | | interference is |
| 7 | Type-1 | | | | Type-3 | not considered. |
| | CSI-RS | | | | CSI-RS | For interference |
| 8 | Type-1 | | | Type-2 | Type-3 | measurement, |
| | CSI-RS | | | CSI-RS | CSI-RS | both inter-cell |
| 9 | Type-1 | | | Type-2 | Type-3 | interference |
| | CSI-RS | | | CSI-IM | CSI-RS | and intra-cell |
| 10 | Type-1 | Type-1 | | Type-2 | | interference |
| | CSI-RS | CSI-IM | | CSI-RS | | are considered |
| 11 | Type-1 | Type-1 | | Type-2 | | |
| | CSI-RS | CSI-IM | | CSI-IM | | |
| 12 | Type-1 | Type-1 | | | Type-3 | |
| | CSI-RS | CSI-IM | | | CSI-RS | |
| 13 | Type-1 | Type-1 | | Type-2 | | |
| | CSI-RS | CSI-RS | | CSI-RS | | |
| 14 | Type-1 | Type-1 | | Type-2 | | |
| | CSI-RS | CSI-RS | | CSI-IM | | |
| 15 | Type-1 | Type-1 | | | Type-3 | |
| | CSI-RS | CSI-RS | | | CSI-RS | |
| 16 | | | Type-2 | | | For L1-RSRP, |
| | | | CSI-RS | | | Type-2 |
| | | | | | | CSI-RS is for |
| | | | | | | channel |
| | | | | | | measurement; |
| | | | | | | For L1-SINR, |
| | | | | | | Type-2 |
| | | | | | | CSI-RS is for |
| | | | | | | channel and |
| | | | | | | interference |
| | | | | | | measurement |
| 17 | | Type-1 | Type-2 | | | For channel |
| | | CSI-IM | CSI-RS | | | measurement, |
| | | | | | | intra-cell |
| | | | | | | interference |
| | | | | | | is considered. |
| | | | | | | For interference |
| | | | | | | measurement, |
| | | | | | | both inter-cell |
| | | | | | | interference |
| | | | | | | and intra-cell |
| | | | | | | interference |
| | | | | | | are considered |
| 18 | | Type-1 | Type-2 | | | For channel |
| | | CSI-RS | CSI-RS | | | measurement, |
| 19 | | Type-1 | Type-2 | | | intra-cell |
| | | CSI-IM + | CSI-RS | | | interference |
| | | Type-1 | | | | is considered. |
| | | CSI-RS | | | | For interference |
| | | | | | | measurement, |
| | | | | | | only inter-cell |
| | | | | | | interference |
| | | | | | | is considered |
| 20 | | | Type-2 | Type-2 | | 3 resource |
| | | | CSI-RS | CSI-RS | | settings. For |
| 21 | | | Type-2 | Type-2 | | channel |
| | | | CSI-RS | CSI-IM | | measurement, |
| 22 | | | Type-2 | | Type-3 | intra-cell |
| | | | CSI-RS | | CSI-RS | interference |
| 23 | | | Type-2 | Type-2 | Type-3 | is considered. |
| | | | CSI-RS | CSI-RS | CSI-RS | For interference |
| 24 | | | Type-2 | Type-2 | Type-3 | measurement, |
| | | | CSI-RS | CSI-IM | CSI-RS | both inter-cell |
| 25 | | Type-1 | Type-2 | Type-2 | | interference |
| | | CSI-IM | CSI-RS | CSI-RS | | and intra-cell |
| 26 | | Type-1 | Type-2 | Type-2 | | interference |
| | | CSI-IM | CSI-RS | CSI-IM | | are considered |
| 27 | | Type-1 | Type-2 | | Type-3 | |
| | | CSI-IM | CSI-RS | | CSI-RS | |
| 28 | | Type-1 | Type-2 | Type-2 | | |
| | | CSI-RS | CSI-RS | CSI-RS | | |
| 29 | | Type-1 | Type-2 | Type-2 | | |
| | | CSI-RS | CSI-RS | CSI-IM | | |
| 30 | | Type-1 | Type-2 | | Type-3 | |
| | | CSI-RS | CSI-RS | | CSI-RS | |
| 31 | | Type-1 | Type-2 | Type-2 | Type-3 | For channel |
| | | CSI-IM | CSI-RS | CSI-IM | CSI-RS | measurement, |
| 32 | | Type-1 | Type-2 | Type-2 | Type-3 | intra-cell |
| | | CSI-IM | CSI-RS | CSI-RS | CSI-RS | interference |
| 33 | | Type-1 | Type-2 | Type-2 | Type-3 | is considered. |
| | | CSI-RS | CSI-RS | CSI-IM | CSI-RS | For interference |
| 34 | | Type-1 | Type-2 | Type-2 | Type-3 | measurement, |
| | | CSI-RS | CSI-RS | CSI-RS | CSI-RS | both inter-cell |
| | | | | | | interference |
| | | | | | | and intra-cell |
| | | | | | | interference |
| | | | | | | are considered |
| 35 | | | | Type-2 | | Interference |
| | | | | CSI-RS | | measurement |
| 36 | | | | Type-2 | | report only |
| | | | | CSI-IM | | |
| 37 | | | | | Type-3 | |
| | | | | | CSI-RS | |
| 38 | | | | Type-2 | Type-3 | |
| | | | | CSI-RS | CSI-RS | |
| 39 | | | | Type-2 | Type-3 | |
| | | | | CSI-IM | CSI-RS | |
| 40 | | Type-1 | | Type-2 | Type-3 | |
| | | CSI-IM | | CSI-RS | CSI-RS | |
| 41 | | Type-1 | | Type-2 | Type-3 | |
| | | CSI-IM | | CSI-IM | CSI-RS | |
| 42 | | Type-1 | | Type-2 | Type-3 | |
| | | CSI-RS | | CSI-RS | CSI-RS | |
| 43 | | Type-1 | | Type-2 | Type-3 | |
| | | CSI-RS | | CSI-IM | CSI-RS | |

It should be noted that each index in the above table may represent a CSI-RS resource group, a CSI report configuration (CSI report config), or a CSI-RS resource configuration (CSI-RS resource config).

Optionally, in this embodiment of this application, the foregoing step 203 may include the following step 203a.

Step 203a: The terminal performs channel measurement and report or interference measurement and report on the target resource based on the one or more pieces of CSI-RS resource configuration information and first indication information.

The first indication information indicates at least one of the following:
configuration information corresponding to the target resource; or
a transmission format of the target resource, where the transmission format indicates a transmission direction.

Optionally, in this embodiment of this application, before step 203a, the resource configuration method provided in this embodiment of this application may further include the following step.

Step 203b: The network side device sends the first indication information to the terminal.

Correspondingly, the terminal receives the first indication information sent by the network side device.

In some possible embodiments, the first indication information is carried in at least one of the following:
RRC information;
group-common DCI;
a medium access control (MAC) control element (CE); or
uplink transmission scheduled by using DCI, or downlink transmission scheduled by using DCI.

In some possible embodiments, configuration information of the target resource is used to configure at least one resource set, where each resource set includes at least one resource.

For example, each resource set includes at least one of the following:
a time domain resource (a number, a starting position, an end position, a length, and the like);
a frequency domain resource;
a transmission format of a resource in the resource set;
a CSI-RS resource configuration corresponding to the resource set;
a CSI reporting type corresponding to the resource set;
a frequency domain interval between the resource set and at least one frequency domain resource unit in a transmission format of uplink; or
a frequency domain interval between the resource set and at least one frequency domain resource unit in a transmission format of flexible.

In some possible embodiments, if a CSI-RS resource configuration corresponding to a resource set is not indicated in the first indication information, a default CSI-RS resource configuration configured by using RRC may be used as a corresponding CSI-RS resource configuration, or a last received CSI-RS resource configuration indicated by a network is used as a CSI-RS resource configuration on a corresponding resource set.

In some possible embodiments, if a CSI-RS reporting type corresponding to a resource set is not indicated in the first indication information, a default CSI-RS reporting type configured by using RRC may be used as a corresponding CSI-RS reporting type, or a last received CSI-RS reporting type indicated by a network is used as a CSI-RS reporting type on a corresponding resource set.

In some possible embodiments, the transmission format includes a time domain transmission format and/or a frequency domain transmission format, such as DL, UL, and flexible.

In some possible embodiments, the time domain resource includes at least one of the following: a number of the time domain resource, a starting position of the time domain resource, an end position of the time domain resource, or a length of the time domain resource.

For example, the frequency domain resource includes at least one of the following: a number of the frequency domain resource, a starting position of the frequency domain resource, an end position of the frequency domain resource, or a magnitude of the frequency domain resource.

For example, the CSI reporting type includes at least one of the following: Wideband CQI, subband CQI, PMI, RI, L1-SINR, or L1-RSRP; and a priority of CSI reporting is a low priority or a high priority.

In some possible embodiments, the first indication information indicates at least one of the following: at least one CSI reporting trigger instruction; or at least one reporting mode.

In some possible embodiments, each CSI reporting trigger instruction includes at least one of the following: one or more of CSI-RS resource configurations; a CSI reporting type corresponding to one or more of the CSI-RS resource configurations; a resource set corresponding to one or more of the CSI-RS resource configurations; a frequency domain interval between a downlink resource unit to which one or more of the CSI-RS resource configurations are applicable and at least one frequency domain resource unit in a transmission format of uplink; or a frequency domain interval between a downlink resource unit to which one or more of the CSI-RS resource configurations are applicable and at least one frequency domain resource unit in a transmission format of flexible.

In some possible embodiments, the reporting mode includes at least one of the following:
Mode 1: a measurement reporting mode corresponding to the first CSI-RS resource configuration;
Mode 2: a measurement reporting mode corresponding to the second CSI-RS resource configuration; or
Mode 3: a measurement reporting mode corresponding to the third CSI-RS resource configuration.

For example, Mode 1 may be a measurement reporting mode corresponding to Type-1 CSI-RS.

For example, Mode 2 may be a measurement reporting mode corresponding to Type-2 CSI-RS.

For example, Mode 3 may be a measurement reporting mode corresponding to Type-3 CSI-RS.

The following describes the technical solutions provided in this application by using two embodiments as examples.

It should be noted that the following two embodiments are only examples, and there may be other implementations in actual application.

### Embodiment 1

Step S11: A network side device configures one CSI-RS reporting configuration.

For example, the CSI-RS reporting configuration includes a Type-1 CSI-RS resource and a Type-2 CSI-RS resource.

For example, the CSI-RS reporting configuration may be a periodic CSI reporting configuration or an aperiodic CSI reporting configuration.

Step S12: The terminal receives first indication information.

For example, the first indication information indicates that subband 1 (in a transmission format of DL) corresponds to CSI-RS reporting configuration 1 (for example, being configured with Type-1 CSI-RS), and subband 2 and subband 3 (in a transmission format of DL) correspond to CSI-RS resource 2 (for example, being configured with Type-2 CSI-RS).

Step S13: The terminal performs channel or interference measurement based on the CSI-RS reporting configuration and the first indication information.

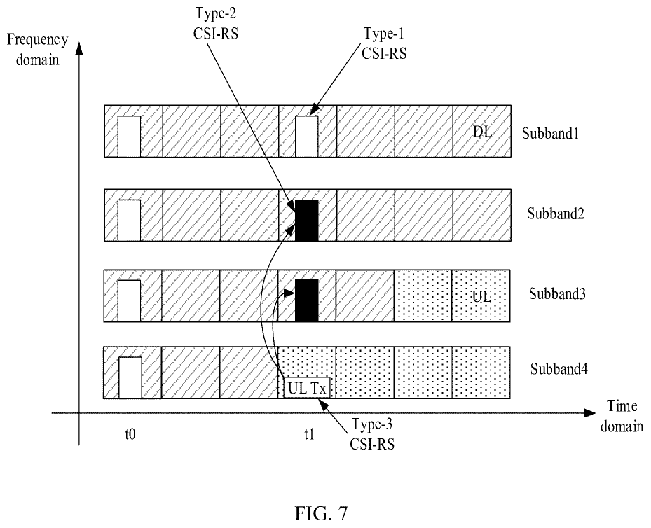

For example, as shown in FIG. 7, at time to, the terminal performs channel or interference measurement on subband 1 to subband 4 based on Type-1 CSI-RS, and reports CSI report 1.

For example, as shown in FIG. 7, at time t1:

when measuring CSI on subband 1, the terminal performs channel or interference measurement based on Type-1 CSI-RS, and reports CSI report 2-1. When measuring CSI on subband 2 and subband 3, the terminal performs channel or interference measurement based on Type-2 CSI-RS, and reports CSI report 2-2.

In conclusion, when the terminal measures CSI at time to, because subband 1 to subband 4 are DL subbands, there is no adjacent channel interference, and the terminal performs channel or interference measurement based on Type-1 CSI-RS. When the terminal measures CSI at time t1, subband 4 is a UL subband. When the terminal measures CSI on subband 1, because subband 1 is separated from subband 4 by 3 subbands, it can be considered that impact of adjacent channel interference is small, and the terminal performs channel or interference measurement based on Type-1 CSI-RS and does not need to consider the adjacent channel interference. However, when the terminal measures CSI on subband 2 and subband 3, because subband 2 and subband 3 are close to or adjacent to a UL subband, the adjacent channel interference may have an impact, and the terminal needs to consider the adjacent channel interference when performing channel or interference measurement based on Type-2 CSI-RS.

In this way, the terminal may be enabled to perform measurement reporting separately when there is no adjacent channel interference impact and when there is adjacent channel interference impact, so that CSI reporting is more accurate, thereby improving transmission performance.

### Embodiment 2

Step S21: A network side device configures two CSI-RS reporting configurations.

For example, the two CSI-RS reporting configurations include a Type-1 CSI-RS resource and a Type-3 CSI-RS resource respectively.

Step S12: The terminal receives first indication information.

For example, the first indication information indicates that Mode 1 is used in a non-full-duplex mode and Mode 3 is used in a full-duplex mode. For example, Mode 1 refers to that a DL subband at time to corresponds to Type-1 CSI-RS; and Mode 2 refers to that DL subband 1 and DL subband 2 at time t1 correspond to CSI-RS resource Type-3 CSI-RS, and a UL subband corresponds to an SRS resource.

Step S13: The terminal performs channel or interference measurement based on the CSI-RS reporting configuration and the first indication information.

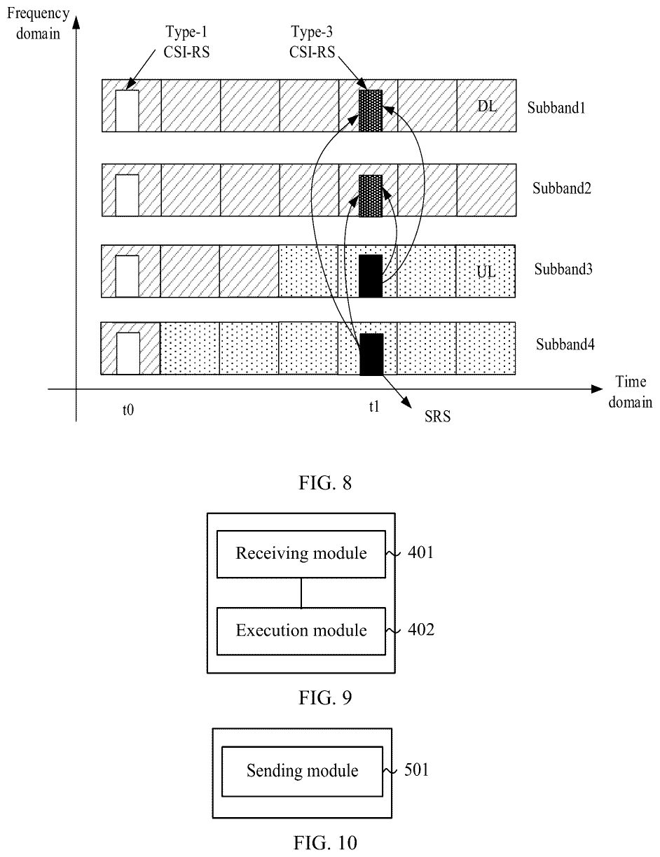

For example, as shown in FIG. 8, at time t0, UE performs channel or interference measurement on subband 1 to subband 4 based on Type-1 CSI-RS, and reports CSI report 1.

For example, as shown in FIG. 8, at time t1:
when measuring CSI on subband 1 and subband 2, the terminal performs interference measurement based on Type-3 CSI-RS (that is, an SRS on UL subband 3 and UL subband 4), and reports CSI report 2.

In conclusion, when the terminal measures CSI at time to, because subband 1 to subband 4 are DL subbands, there is no adjacent channel interference, and the terminal performs channel or interference measurement based on Type-1 CSI-RS. When the terminal measures CSI at time t1, subband 3 and subband 4 are UL subbands. When the terminal measures CSI on subband 1 and subband 2, because subband 1 and subband 2 are close to or adjacent to a UL subband, another terminal may send an SRS on UL subband 3 and UL subband 4, which may cause adjacent channel interference on DL subband 1 and DL subband 2. Therefore, the terminal needs to consider the adjacent channel interference when performing channel or interference measurement based on Type-3 CSI-RS.

In this way, the terminal may be enabled to perform measurement reporting separately when there is no adjacent channel interference impact and when there is adjacent channel interference impact, so that CSI reporting is more accurate, thereby improving transmission performance.

In the resource configuration method provided in this embodiment of this application, a network side device configures one or more pieces of CSI-RS resource configuration information for a terminal, so that the terminal may perform channel measurement and report or interference measurement and report on a target resource based on the one or more pieces of CSI-RS resource configuration information. Because the one or more pieces of CSI-RS resource configuration information are used to configure at least three CSI-RS resource configurations, the terminal may use different CSI-RS resource configurations to measure a channel or interference in different situations, thereby effectively improving transmission performance.

The resource configuration method provided in this embodiment of this application may be executed by a resource configuration apparatus. In the embodiments of this application, that the resource configuration apparatus performs the resource configuration method is used as an example to describe the resource configuration apparatus provided in the embodiments of this application.

An embodiment of this application provides a resource configuration apparatus. As shown in FIG. 9, the apparatus includes a receiving module 401 and an execution module 402, where
the receiving module 401 is configured to receive one or more pieces of CSI-RS resource configuration information sent by a network side device; and the execution module 402 is configured to perform channel measurement and report or interference measurement and report on a target resource based on the one or more pieces of CSI-RS resource configuration information received by the receiving module 401, where the CSI-RS resource configuration information is used to configure at least one of the following: at least one first CSI-RS resource configuration; at least one second CSI-RS resource configuration; or at least one third CSI-RS resource configuration;
the first CSI-RS resource configuration is used for a first resource;
the second CSI-RS resource configuration is used for a second resource; and
the third CSI-RS resource configuration is used for a third resource.

In some possible embodiments, the execution module 402 is configured to perform channel measurement and report or interference measurement and report on a target resource based on the one or more pieces of CSI-RS resource configuration information received by the receiving module 401 and first indication information, where the first indication information indicates at least one of the following:
configuration information corresponding to the target resource; or
a transmission format of the target resource.

In some possible embodiments, the first indication information is carried in at least one of the following: RRC information; group-common downlink control information (DCI); a medium access control (MAC) control element (CE); or uplink transmission scheduled by using DCI, or downlink transmission scheduled by using DCI.

In some possible embodiments, the configuration information is used to configure at least one resource set, where each resource set includes at least one resource; and the each resource set includes at least one of the following:
a time domain resource;
a frequency domain resource;
a transmission format of a resource in the resource set;
a CSI-RS resource configuration corresponding to the resource set;
a CSI reporting type corresponding to the resource set;
a frequency domain interval between the resource set and at least one frequency domain resource unit in a transmission format of uplink; or
a frequency domain interval between the resource set and at least one frequency domain resource unit in a transmission format of flexible.

In some possible embodiments, the first indication information indicates at least one of the following:
at least one CSI reporting trigger instruction; or
at least one reporting mode.

In some possible embodiments, each CSI reporting trigger instruction includes at least one of the following:
one or more of CSI-RS resource configurations;
a CSI reporting type corresponding to one or more of the CSI-RS resource configurations;
a resource set corresponding to one or more of the CSI-RS resource configurations;
a frequency domain interval between a downlink resource unit to which one or more of the CSI-RS resource configurations are applicable and at least one frequency domain resource unit in a transmission format of uplink; or
a frequency domain interval between a downlink resource unit to which one or more of the CSI-RS resource configurations are applicable and at least one frequency domain resource unit in a transmission format of flexible.

In some possible embodiments, the reporting mode includes at least one of the following:
a measurement reporting mode corresponding to the first CSI-RS resource configuration;
a measurement reporting mode corresponding to the second CSI-RS resource configuration; or
a measurement reporting mode corresponding to the third CSI-RS resource configuration.

In some possible embodiments, the first resource meets any one of the following that:
a frequency domain resource unit of the first resource does not overlap with any frequency domain resource unit in a transmission format of uplink or flexible;
a frequency domain interval between a frequency domain resource unit of the first resource and a frequency domain resource unit in a transmission format of uplink or flexible is greater than or equal to N first frequency domain resource units; and
a frequency domain interval between a center frequency of the first resource and a center frequency of a frequency domain resource unit in a transmission format of uplink or flexible is greater than or equal to M second frequency domain resource units, where
N and M are positive integers.

In some possible embodiments, the second resource meets at least one of the following that:
a frequency domain resource unit of the second resource overlaps with a frequency domain resource unit in a transmission format of uplink or flexible;
a frequency domain resource unit of the second resource does not overlap with a frequency domain resource unit in a transmission format of uplink or flexible, and a frequency domain interval between the frequency domain resource unit of the second resource and a frequency domain resource unit in a transmission format of uplink or flexible is less than or equal to X third frequency domain resource units; or
a frequency domain resource unit of the second resource does not overlap with a frequency domain resource unit in a transmission format of uplink or flexible, and a frequency domain interval between a center frequency of the second resource and a center frequency of a frequency domain resource unit in a transmission format of uplink or flexible is less than or equal to Y fourth frequency domain resource units, where
X and Y are positive integers.

In some possible embodiments, the third resource meets at least one of the following that:
a frequency domain resource unit of the third resource overlaps with a frequency domain resource unit in a transmission format of uplink or flexible;
a frequency domain resource unit of the third resource does not overlap with a frequency domain resource unit in a transmission format of uplink or flexible, and a frequency domain interval between the frequency domain resource unit of the third resource and a frequency domain resource unit in a transmission format of uplink or flexible is less than or equal to X frequency domain resource units; or
a frequency domain resource unit of the third resource does not overlap with a frequency domain resource unit in a transmission format of uplink or flexible, and a frequency domain interval between a center frequency of the third resource and a center frequency of a frequency domain resource unit in a transmission format of uplink or flexible is less than or equal to Y frequency domain resource units, where
X and Y are positive integers.

In some possible embodiments, the third CSI-RS resource configuration further includes a resource configuration for an uplink reference signal.

In some possible embodiments, the third CSI-RS resource configuration further includes a fourth resource, where the fourth resource is a transmission resource of the uplink reference signal.

In some possible embodiments, the uplink reference signal is an uplink reference signal sent by another terminal.

In some possible embodiments, a transmission format of the fourth resource is uplink.

In some possible embodiments, spatial correlation of the uplink reference signal is associated with the first CSI-RS resource configuration or the second CSI-RS resource configuration.

In some possible embodiments, the one or more pieces of CSI-RS resource configuration information are used to configure at least one of the following: a periodic or semi-persistent CSI-RS resource; an aperiodic CSI-RS resource; periodic or semi-persistent CSI reporting; or aperiodic CSI reporting.

In the resource configuration apparatus provided in this embodiment of this application, the apparatus receives one or more pieces of CSI-RS resource configuration information configured by a network side device for a terminal, so that the terminal may perform channel measurement and report or interference measurement and report on a target resource based on the one or more pieces of CSI-RS resource configuration information. Because the one or more pieces of CSI-RS resource configuration information are used to configure at least three CSI-RS resource configurations, the terminal may use different CSI-RS resource configurations to measure a channel or interference in different situations, thereby effectively improving transmission performance.

An embodiment of this application provides a resource configuration apparatus. As shown in FIG. 10, the apparatus includes a sending module 501:
the sending module 501 is configured to send one or more pieces of CSI-RS resource configuration information to a terminal, where
the CSI-RS resource configuration information is used to configure at least one of the following: at least one first CSI-RS resource configuration; at least one second CSI-RS resource configuration; or at least one third CSI-RS resource configuration; and
the first CSI-RS resource configuration is used for a first resource; the second CSI-RS resource configuration is used for a second resource; and the third CSI-RS resource configuration is used for a third resource.

In some possible embodiments, the sending module 501 is further configured to send first indication information to the terminal, where
the first indication information indicates the terminal to perform channel measurement and report or interference measurement and report on a target resource; and the first indication information indicates at least one of the following: configuration information corresponding to the target resource; or a transmission format of the target resource.

In some possible embodiments, the first indication information is carried in at least one of the following: RRC information; group-common DCI; a MAC CE; or
uplink transmission scheduled by using DCI, or downlink transmission scheduled by using DCI.

In some possible embodiments, the configuration information is used to configure at least one resource set, where each resource set includes at least one resource; and the each resource set includes at least one of the following:
a time domain resource;
a frequency domain resource;
a transmission format of a resource in the resource set;
a CSI-RS resource configuration corresponding to the resource set;
a CSI reporting type corresponding to the resource set;
a frequency domain interval between the resource set and at least one frequency domain resource unit in a transmission format of uplink; or
a frequency domain interval between the resource set and at least one frequency domain resource unit in a transmission format of flexible.

In some possible embodiments, the first indication information indicates at least one of the following:
at least one CSI reporting trigger instruction; or
at least one reporting mode.

In some possible embodiments, each CSI reporting trigger instruction includes at least one of the following:
one or more of CSI-RS resource configurations;
a CSI reporting type corresponding to one or more of the CSI-RS resource configurations;
a resource set corresponding to one or more of the CSI-RS resource configurations;
a frequency domain interval between a downlink resource unit to which one or more of the CSI-RS resource configurations are applicable and at least one frequency domain resource unit in a transmission format of uplink; or
a frequency domain interval between a downlink resource unit to which one or more of the CSI-RS resource configurations are applicable and at least one frequency domain resource unit in a transmission format of flexible.

In some possible embodiments, the reporting mode includes at least one of the following:
a measurement reporting mode corresponding to the first CSI-RS resource configuration;
a measurement reporting mode corresponding to the second CSI-RS resource configuration; or
a measurement reporting mode corresponding to the third CSI-RS resource configuration.

In some possible embodiments, the first resource meets any one of the following that: a frequency domain resource unit of the first resource does not overlap with any frequency domain resource unit in a transmission format of uplink or flexible;
a frequency domain interval between a frequency domain resource unit of the first resource and a frequency domain resource unit in a transmission format of uplink or flexible is greater than or equal to N first frequency domain resource units; and
a frequency domain interval between a center frequency of the first resource and a center frequency of a frequency domain resource unit in a transmission format of uplink or flexible is greater than or equal to M second frequency domain resource units, where
N and M are positive integers.

In some possible embodiments, the second resource meets at least one of the following that:
a frequency domain resource unit of the second resource overlaps with a frequency domain resource unit in a transmission format of uplink or flexible;
a frequency domain resource unit of the second resource does not overlap with a frequency domain resource unit in a transmission format of uplink or flexible, and a frequency domain interval between the frequency domain resource unit of the second resource and a frequency domain resource unit in a transmission format of uplink or flexible is less than or equal to X third frequency domain resource units; or
a frequency domain resource unit of the second resource does not overlap with a frequency domain resource unit in a transmission format of uplink or flexible, and a frequency domain interval between a center frequency of the second resource and a center frequency of a frequency domain resource unit in a transmission format of uplink or flexible is less than or equal to Y fourth frequency domain resource units, where
X and Y are positive integers.

In some possible embodiments, the third resource meets at least one of the following that:
a frequency domain resource unit of the third resource overlaps with a frequency domain resource unit in a transmission format of uplink or flexible;
a frequency domain resource unit of the third resource does not overlap with a frequency domain resource unit in a transmission format of uplink or flexible, and a frequency domain interval between the frequency domain resource unit of the third resource and a frequency domain resource unit in a transmission format of uplink or flexible is less than or equal to X frequency domain resource units; or
a frequency domain resource unit of the third resource does not overlap with a frequency domain resource unit in a transmission format of uplink or flexible, and a frequency domain interval between a center frequency of the third resource and a center frequency of a frequency domain resource unit in a transmission format of uplink or flexible is less than or equal to Y frequency domain resource units, where
X and Y are positive integers.

In some possible embodiments, the third CSI-RS resource configuration further includes a resource configuration for an uplink reference signal.

In some possible embodiments, the third CSI-RS resource configuration further includes a fourth resource, where
the fourth resource is a transmission resource of the uplink reference signal.

In some possible embodiments, the uplink reference signal is an uplink reference signal sent by another terminal.

In some possible embodiments, a transmission format of the fourth resource is uplink.

In some possible embodiments, spatial correlation of the uplink reference signal is associated with the first CSI-RS resource configuration or the second CSI-RS resource configuration.

In some possible embodiments, the one or more pieces of CSI-RS resource configuration information are used to configure at least one of the following: a periodic or semi-persistent CSI-RS resource; an aperiodic CSI-RS resource; periodic or semi-persistent CSI reporting; or aperiodic CSI reporting.

In the resource configuration apparatus provided in this embodiment of this application, the apparatus uses one or more pieces of CSI-RS resource configuration information configured for a terminal, so that the terminal may perform channel measurement and report or interference measurement and report on a target resource based on the one or more pieces of CSI-RS resource configuration information. Because the one or more pieces of CSI-RS resource configuration information are used to configure at least three CSI-RS resource configurations, the terminal may use different CSI-RS resource configurations to measure a channel or interference in different situations, thereby effectively improving transmission performance.

The resource configuration apparatus in this embodiment of this application may be an electronic device, for example, an electronic device with an operating system, or may be a component in the electronic device, for example, an integrated circuit or a chip. The electronic device may be a terminal, or another device other than the terminal. For example, the terminal may include but is not limited to the foregoing listed types of the terminal 11. The another device may be a server, a network attached storage (NAS), and the like. This is not limited in this embodiment of this application.

The resource configuration apparatus provided in this embodiment of this application can implement the processes implemented in the foregoing method embodiment, and achieve a same technical effect. To avoid repetition, details are not described herein again.

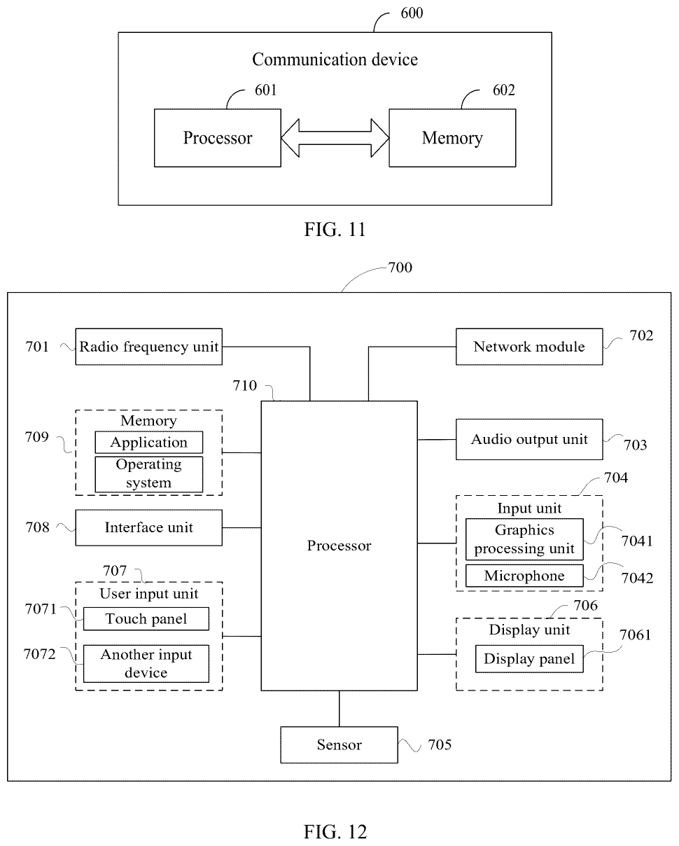

Optionally, as shown in FIG. 11, an embodiment of this application further provides a communication device 600, including a processor 601 and a memory 602. The memory 602 stores a program or an instruction executable on the processor 601. For example, when the communication device 600 is a terminal, when the program or the instruction is executed by the processor 601, steps of the resource configuration method embodiment can be implemented, and a same technical effect can be achieved. In a case that the communication device 600 is a network side device, when the program or the instruction is executed by the processor 601, the steps of the resource configuration method embodiment are implemented, and a same technical effect can be achieved. To avoid repetition, details are not described herein again.

An embodiment of this application further provides a terminal, including a processor and a communication interface, where the communication interface is configured to receive one or more pieces of CSI-RS resource configuration information sent by a network side device; and the processor is configured to perform channel measurement and report or interference measurement and report on a target resource based on the one or more pieces of CSI-RS resource configuration information, where the CSI-RS resource configuration information is used to configure at least one of the following: at least one first CSI-RS resource configuration; at least one second CSI-RS resource configuration; or at least one third CSI-RS resource configuration; the first CSI-RS resource configuration is used for a first resource; the second CSI-RS resource configuration is used for a second resource; and the third CSI-RS resource configuration is used for a third resource. The terminal embodiment is corresponding to the terminal side method embodiment, each implementation process and implementation of the method embodiment can be applied to the terminal embodiment, and a same technical effect can be achieved. Optionally, FIG. 12 is a schematic diagram of a hardware structure of a terminal according to an embodiment of this application.

A terminal 700 includes but is not limited to at least a part of components such as a radio frequency unit 701, a network module 702, an audio output unit 703, an input unit 704, a sensor 705, a display unit 706, a user input unit 707, an interface unit 708, a memory 709, and a processor 710.

A person skilled in the art can understand that the terminal 700 may further include a power supply (such as a battery) that supplies power to each component. The power supply may be logically connected to the processor 710 by using a power supply management system, to implement functions such as charging and discharging management, and power consumption management by using the power supply management system. The terminal structure shown in FIG. 12 constitutes no limitation on the terminal, and the terminal may include more or fewer components than those shown in the figure, or combine some components, or have different component arrangements. Details are not described herein.

It should be understood that in this embodiment of this application, the input unit 704 may include a graphics processing unit (GPU) 7041 and a microphone 7042. The graphics processing unit 7041 processes image data of a static picture or a video obtained by an image capture apparatus (for example, a camera) in a video capture mode or an image capture mode. The display unit 706 may include a display panel 7061, and the display panel 7061 may be configured in a form of a liquid crystal display, an organic light-emitting diode, or the like. The user input unit 707 includes at least one of a touch panel 7071 and another input device 7072. The touch panel 7071 is also referred to as a touchscreen. The touch panel 7071 may include two parts: a touch detection apparatus and a touch controller. The another input device 7072 may include but is not limited to a physical keyboard, a functional button (such as a volume control button or a power on/off button), a trackball, a mouse, and a joystick. Details are not described herein.

In this embodiment of this application, after receiving downlink data from a network side device, the radio frequency unit 701 may transmit the downlink data to the processor 710 for processing. In addition, the radio frequency unit 701 may send uplink data to the network side device. Generally, the radio frequency unit 701 includes but is not limited to an antenna, an amplifier, a transceiver, a coupler, a low noise amplifier, a duplexer, and the like.

The memory 709 may be configured to store a software program or an instruction and various data. The memory 709 may mainly include a first storage area for storing a program or an instruction and a second storage area for storing data. The first storage area may store an operating system, and an application or an instruction required by at least one function (for example, a sound playing function or an image playing function). In addition, the memory 709 may be a volatile memory or a non-volatile memory, or the memory 709 may include a volatile memory and a non-volatile memory. The non-volatile memory may be a read-only memory (ROM), a programmable read-only memory (PROM), an erasable programmable read-only memory (EPROM), an electrically erasable programmable read-only memory (EEPROM), or a flash memory. The volatile memory may be a random access memory (RAM), a static random access memory (SRAM), a dynamic random access memory (DRAM), a synchronous dynamic random access memory (SDRAM), a double data rate synchronous dynamic random access memory (DDRSDRAM), an enhanced synchronous dynamic random access memory (ESDRAM), a synchlink dynamic random access memory (SLDRAM), and a direct rambus random access memory (DRRAM). The memory 709 in this embodiment of this application includes but is not limited to these memories and any memory of another proper type.

The processor 710 may include one or more processing units. Optionally, an application processor and a modem processor are integrated into the processor 710. The application processor mainly processes an operating system, a user interface, an application, or the like. The modem processor mainly processes a wireless communication signal, for example, a baseband processor. It may be understood that, alternatively, the modem processor may not be integrated into the processor 710.

The radio frequency unit 701 is configured to receive one or more pieces of CSI-RS resource configuration information sent by a network side device; and the processor 710 is configured to perform channel measurement and report or interference measurement and report on a target resource based on the one or more pieces of CSI-RS resource configuration information received by the radio frequency unit 701, where the CSI-RS resource configuration information is used to configure at least one of the following: at least one first CSI-RS resource configuration; at least one second CSI-RS resource configuration; or at least one third CSI-RS resource configuration; and the first CSI-RS resource configuration is used for a first resource; the second CSI-RS resource configuration is used for a second resource; and the third CSI-RS resource configuration is used for a third resource.

In some possible embodiments, the processor 710 is configured to perform channel measurement and report or interference measurement and report on a target resource based on the one or more pieces of CSI-RS resource configuration information received by the radio frequency unit 701 and first indication information, where the first indication information indicates at least one of the following: configuration information corresponding to the target resource; or a transmission format of the target resource.

In some possible embodiments, the first indication information is carried in at least one of the following: RRC information; group-common downlink control information (DCI); a medium access control (MAC) control element (CE); or uplink transmission scheduled by using DCI, or downlink transmission scheduled by using DCI.

In some possible embodiments, the configuration information is used to configure at least one resource set, where
each resource set includes at least one resource; and
the each resource set includes at least one of the following: a time domain resource; a frequency domain resource; a transmission format of a resource in the resource set; a CSI-RS resource configuration corresponding to the resource set; a CSI reporting type corresponding to the resource set;
a frequency domain interval between the resource set and at least one frequency domain resource unit in a transmission format of uplink; or
a frequency domain interval between the resource set and at least one frequency domain resource unit in a transmission format of flexible.

In some possible embodiments, the first indication information indicates at least one of the following:
at least one CSI reporting trigger instruction; or
at least one reporting mode.

In some possible embodiments, each CSI reporting trigger instruction includes at least one of the following:
one or more of CSI-RS resource configurations;
a CSI reporting type corresponding to one or more of the CSI-RS resource configurations;
a resource set corresponding to one or more of the CSI-RS resource configurations;
a frequency domain interval between a downlink resource unit to which one or more of the CSI-RS resource configurations are applicable and at least one frequency domain resource unit in a transmission format of uplink; or
a frequency domain interval between a downlink resource unit to which one or more of the CSI-RS resource configurations are applicable and at least one frequency domain resource unit in a transmission format of flexible.

In some possible embodiments, the reporting mode includes at least one of the following:
a measurement reporting mode corresponding to the first CSI-RS resource configuration;
a measurement reporting mode corresponding to the second CSI-RS resource configuration; or
a measurement reporting mode corresponding to the third CSI-RS resource configuration.

In some possible embodiments, the first resource meets any one of the following that:
a frequency domain resource unit of the first resource does not overlap with any frequency domain resource unit in a transmission format of uplink or flexible;
a frequency domain interval between a frequency domain resource unit of the first resource and a frequency domain resource unit in a transmission format of uplink or flexible is greater than or equal to N first frequency domain resource units; and
a frequency domain interval between a center frequency of the first resource and a center frequency of a frequency domain resource unit in a transmission format of uplink or flexible is greater than or equal to M second frequency domain resource units, where
N and M are positive integers.

In some possible embodiments, the second resource meets at least one of the following that:
a frequency domain resource unit of the second resource overlaps with a frequency domain resource unit in a transmission format of uplink or flexible;
a frequency domain resource unit of the second resource does not overlap with a frequency domain resource unit in a transmission format of uplink or flexible, and a frequency domain interval between the frequency domain resource unit of the second resource and a frequency domain resource unit in a transmission format of uplink or flexible is less than or equal to X third frequency domain resource units; or
a frequency domain resource unit of the second resource does not overlap with a frequency domain resource unit in a transmission format of uplink or flexible, and a frequency domain interval between a center frequency of the second resource and a center frequency of a frequency domain resource unit in a transmission format of uplink or flexible is less than or equal to Y fourth frequency domain resource units, where
X and Y are positive integers.

In some possible embodiments, the third resource meets at least one of the following that:
a frequency domain resource unit of the third resource overlaps with a frequency domain resource unit in a transmission format of uplink or flexible;
a frequency domain resource unit of the third resource does not overlap with a frequency domain resource unit in a transmission format of uplink or flexible, and a frequency domain interval between the frequency domain resource unit of the third resource and a frequency domain resource unit in a transmission format of uplink or flexible is less than or equal to X frequency domain resource units; or
a frequency domain resource unit of the third resource does not overlap with a frequency domain resource unit in a transmission format of uplink or flexible, and a frequency domain interval between a center frequency of the third resource and a center frequency of a frequency domain resource unit in a transmission format of uplink or flexible is less than or equal to Y frequency domain resource units, where
X and Y are positive integers.

In some possible embodiments, the third CSI-RS resource configuration further includes a resource configuration for an uplink reference signal.

In some possible embodiments, the third CSI-RS resource configuration further includes a fourth resource, where the fourth resource is a transmission resource of the uplink reference signal.

In some possible embodiments, the uplink reference signal is an uplink reference signal sent by another terminal.

In some possible embodiments, a transmission format of the fourth resource is uplink.

In some possible embodiments, spatial correlation of the uplink reference signal is associated with the first CSI-RS resource configuration or the second CSI-RS resource configuration.

In some possible embodiments, the one or more pieces of CSI-RS resource configuration information are used to configure at least one of the following:
a periodic or semi-persistent CSI-RS resource;
an aperiodic CSI-RS resource;
periodic or semi-persistent CSI reporting; or
aperiodic CSI reporting.

In the terminal provided in this embodiment of this application, the terminal receives one or more pieces of CSI-RS resource configuration information configured by a network side device for the terminal, so that the terminal may perform channel measurement and report or interference measurement and report on a target resource based on the one or more pieces of CSI-RS resource configuration information. Because the one or more pieces of CSI-RS resource configuration information are used to configure at least three CSI-RS resource configurations, the terminal may use different CSI-RS resource configurations to measure a channel or interference in different situations, thereby effectively improving transmission performance.

An embodiment of this application further provides a network side device, including a processor and a communication interface. The communication interface is configured to send one or more pieces of CSI-RS resource configuration information to a terminal, where the CSI-RS resource configuration information is used to configure at least one of the following: at least one first CSI-RS resource configuration; at least one second CSI-RS resource configuration; or at least one third CSI-RS resource configuration; the first CSI-RS resource configuration is used for a first resource; the second CSI-RS resource configuration is used for a second resource; and the third CSI-RS resource configuration is used for a third resource. This network side device embodiment is corresponding to the foregoing method embodiment of the network side device. Each implementation process and implementation of the foregoing method embodiment may be applicable to this network side device embodiment, and a same technical effect can be achieved.

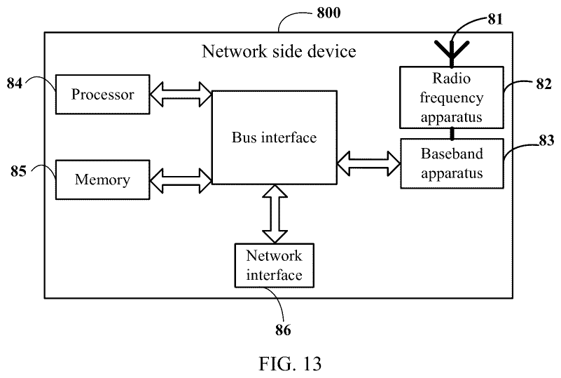

Optionally, an embodiment of this application further provides a network side device. As shown in FIG. 13, the network side device 800 includes an antenna 81, a radio frequency apparatus 82, a baseband apparatus 83, a processor 84, and a memory 85. The antenna 81 is connected to the radio frequency apparatus 82. In an uplink direction, the radio frequency apparatus 82 receives information by using the antenna 81, and sends the received information to the baseband apparatus 83 for processing. In a downlink direction, the baseband apparatus 83 processes information that needs to be sent, and sends processed information to the radio frequency apparatus 82. The radio frequency apparatus 82 processes the received information, and sends processed information by using the antenna 81.

In the foregoing embodiment, the method performed by the network side device may be implemented in a baseband apparatus 83. The baseband apparatus 83 includes a baseband processor.

For example, the baseband apparatus 83 may include at least one baseband board. A plurality of chips are disposed on the baseband board. As shown in FIG. 13, one chip is, for example, a baseband processor, and is connected to the memory 85 by using a bus interface, to invoke a program in the memory 85 to perform the operations of the network device shown in the foregoing method embodiment.

The network side device may further include a network interface 86, and the interface is, for example, a common public radio interface (CPRI).

Optionally, the network side device 800 in this embodiment of the present application further includes an instruction or a program that is stored in the memory 85 and executable on the processor 84. The processor 84 invokes the instruction or the program in the memory 85 to perform the method performed by the modules shown in FIG. 10, and a same technical effect is achieved. To avoid repetition, details are not described herein again.

An embodiment of this application further provides a non-transitory readable storage medium. The non-transitory readable storage medium stores a program or an instruction, and when the program or the instruction is executed by a processor, the processes of the foregoing resource configuration method embodiment are implemented, and a same technical effect can be achieved. To avoid repetition, details are not described herein again.

The processor is a processor in the terminal in the foregoing embodiments. The non-transitory readable storage medium includes a non-transitory computer-readable storage medium, such as a computer read-only memory ROM, a random access memory RAM, a magnetic disk, or an optical disc.

An embodiment of this application further provides a chip. The chip includes a processor and a communication interface, the communication interface is coupled to the processor, and the processor is configured to run a program or an instruction to implement the processes of the resource configuration method embodiment, and a same technical effect can be achieved. To avoid repetition, details are not described herein again.

It should be understood that the chip mentioned in this embodiment of this application may also be referred to as a system-level chip, a system chip, a chip system, or an on-chip system chip.

An embodiment of this application further provides a computer program/program product. The computer program/program product is stored in a non-transitory storage medium, and the computer program/program product is executed by at least one processor to implement the processes of the resource configuration method embodiment, and a same technical effect can be achieved. To avoid repetition, details are not described herein again.

An embodiment of this application further provides a communication system, including a terminal and a network side device, where the terminal may be configured to perform the steps of the resource configuration method performed by a terminal, and the network side device may be configured to perform the steps of the resource configuration method performed by a network side device.

It should be noted that, in this specification, the term “include”, “comprise”, or any other variant thereof is intended to cover a non-exclusive inclusion, so that a process, a method, an article, or an apparatus that includes a list of elements not only includes those elements but also includes other elements which are not expressly listed, or further includes elements inherent to this process, method, article, or apparatus. In absence of more constraints, an element preceded by “includes a . . . ” does not preclude the existence of other identical elements in the process, method, article, or apparatus that includes the element. In addition, it should be noted that the scope of the methods and apparatuses in the embodiments of this application is not limited to performing functions in the order shown or discussed, but may also include performing the functions in a basically simultaneous manner or in opposite order based on the functions involved. For example, the described methods may be performed in a different order from the described order, and various steps may be added, omitted, or combined. In addition, features described with reference to some examples may be combined in other examples.

Based on the descriptions of the foregoing implementations, a person skilled in the art may clearly understand that the method in the foregoing embodiment may be implemented by software in addition to a necessary universal hardware platform or by hardware only. Based on such an understanding, the technical solutions of this application essentially or the part contributing to the prior art may be implemented in a form of a computer software product. The computer software product is stored in a storage medium (for example, a ROM/RAM, a floppy disk, or an optical disc), and includes several instructions for instructing a terminal (which may be a mobile phone, a computer, a server, an air conditioner, a network device, or the like) to perform the methods described in the embodiments of this application.

The embodiments of this application are described above with reference to the accompanying drawings, but this application is not limited to the foregoing implementations, and the foregoing implementations are only illustrative and not restrictive. Under the enlightenment of this application, a person of ordinary skill in the art can make many forms without departing from the purpose of this application and the protection scope of the claims, all of which fall within the protection of this application.

What is claimed is:

1. A resource configuration method, comprising:
receiving, by a terminal, one or more pieces of channel state information reference signal (CSI-RS) resource configuration information sent by a network side device; and
performing, by the terminal, channel measurement and report or interference measurement and report on a target resource based on the one or more pieces of CSI-RS resource configuration information, wherein
the CSI-RS resource configuration information is used to configure at least one of the following:
at least one first CSI-RS resource configuration;
at least one second CSI-RS resource configuration; or
at least one third CSI-RS resource configuration;
the first CSI-RS resource configuration is used for a first resource;
the second CSI-RS resource configuration is used for a second resource; and
the third CSI-RS resource configuration is used for a third resource.

2. The method according to claim 1, wherein the performing, by the terminal, channel measurement and report or interference measurement and report on a target resource based on the one or more pieces of CSI-RS resource configuration information comprises:
performing, by the terminal, channel measurement and report or interference measurement and report on the target resource based on the one or more pieces of CSI-RS resource configuration information and first indication information, wherein
the first indication information indicates at least one of the following:
configuration information corresponding to the target resource; or
a transmission format of the target resource.

3. The method according to claim 2, wherein the first indication information is carried in at least one of the following:
radio resource control (RRC) information;
group-common downlink control information (DCI);
a medium access control (MAC) control element (CE); or
uplink transmission scheduled by using DCI, or downlink transmission scheduled by using DCI.

4. The method according to claim 2, wherein
the configuration information is used to configure at least one resource set, wherein each resource set comprises at least one resource; and
the each resource set comprises at least one of the following:
a time domain resource;
a frequency domain resource;
a transmission format of a resource in the resource set;
a CSI-RS resource configuration corresponding to the resource set;
a CSI reporting type corresponding to the resource set;
a frequency domain interval between the resource set and at least one frequency domain resource unit in a transmission format of uplink; or
a frequency domain interval between the resource set and at least one frequency domain resource unit in a transmission format of flexible.

5. The method according to claim 2, wherein the first indication information indicates at least one of the following:
at least one CSI reporting trigger instruction; or
at least one reporting mode.

6. The method according to claim 5, wherein each CSI reporting trigger instruction comprises at least one of the following:
one or more of CSI-RS resource configurations;
a CSI reporting type corresponding to one or more of the CSI-RS resource configurations;
a resource set corresponding to one or more of the CSI-RS resource configurations;
a frequency domain interval between a downlink resource unit to which one or more of the CSI-RS resource configurations are applicable and at least one frequency domain resource unit in a transmission format of uplink; or
a frequency domain interval between a downlink resource unit to which one or more of the CSI-RS resource configurations are applicable and at least one frequency domain resource unit in a transmission format of flexible;
or,
the reporting mode comprises at least one of the following:
a measurement reporting mode corresponding to the first CSI-RS resource configuration;
a measurement reporting mode corresponding to the second CSI-RS resource configuration; or
a measurement reporting mode corresponding to the third CSI-RS resource configuration.

7. The method according to claim 1, wherein the first resource meets any one of the following that:
a frequency domain resource unit of the first resource does not overlap with any frequency domain resource unit in a transmission format of uplink or flexible;
a frequency domain interval between a frequency domain resource unit of the first resource and a frequency domain resource unit in a transmission format of uplink or flexible is greater than or equal to N first frequency domain resource units; and
a frequency domain interval between a center frequency of the first resource and a center frequency of a frequency domain resource unit in a transmission format of uplink or flexible is greater than or equal to M second frequency domain resource units, wherein
N and M are positive integers;
or,
the second resource meets at least one of the following that:
a frequency domain resource unit of the second resource overlaps with a frequency domain resource unit in a transmission format of uplink or flexible;
a frequency domain resource unit of the second resource does not overlap with a frequency domain resource unit in a transmission format of uplink or flexible, and a frequency domain interval between the frequency domain resource unit of the second resource and the frequency domain resource unit in the transmission format of uplink or flexible is less than or equal to X third frequency domain resource units; or
a frequency domain resource unit of the second resource does not overlap with a frequency domain resource unit in a transmission format of uplink or flexible, and a frequency domain interval between a center frequency of the second resource and a center frequency of the frequency domain resource unit in the transmission format of uplink or flexible is less than or equal to Y fourth frequency domain resource units, wherein
X and Y are positive integers;
or,
the third resource meets at least one of the following that:
a frequency domain resource unit of the third resource overlaps with a frequency domain resource unit in a transmission format of uplink or flexible;
a frequency domain resource unit of the third resource does not overlap with a frequency domain resource unit in a transmission format of uplink or flexible, and a frequency domain interval between the frequency domain resource unit of the third resource and the frequency domain resource unit in the transmission format of uplink or flexible is less than or equal to X frequency domain resource units; or
a frequency domain resource unit of the third resource does not overlap with a frequency domain resource unit in a transmission format of uplink or flexible, and a frequency domain interval between a center frequency of the third resource and a center frequency of the frequency domain resource unit in the transmission format of uplink or flexible is less than or equal to Y frequency domain resource units, wherein
X and Y are positive integers.

8. The method according to claim 1, wherein the third CSI-RS resource configuration further comprises a resource configuration for an uplink reference signal.

9. The method according to claim 8, wherein the third CSI-RS resource configuration further comprises a fourth resource, wherein
the fourth resource is a transmission resource of the uplink reference signal; wherein
a transmission format of the fourth resource is uplink.

10. The method according to claim 8, wherein the uplink reference signal is an uplink reference signal sent by another terminal;
or,
spatial correlation of the uplink reference signal is associated with the first CSI-RS resource configuration or the second CSI-RS resource configuration.

11. The method according to claim 1, wherein the one or more pieces of CSI-RS resource configuration information are used to configure at least one of the following:
a periodic or semi-persistent CSI-RS resource;
an aperiodic CSI-RS resource;
periodic or semi-persistent CSI reporting; or
aperiodic CSI reporting.

12. A resource configuration method, comprising:
sending, by a network side device, one or more pieces of channel state information reference signal (CSI-RS) resource configuration information to a terminal, wherein
the CSI-RS resource configuration information is used to configure at least one of the following:
at least one first CSI-RS resource configuration;
at least one second CSI-RS resource configuration; or
at least one third CSI-RS resource configuration;
the first CSI-RS resource configuration is used for a first resource;
the second CSI-RS resource configuration is used for a second resource; and
the third CSI-RS resource configuration is used for a third resource.

13. The method according to claim 12, wherein the method further comprises:
sending, by the network side device, first indication information to the terminal, wherein
the first indication information indicates the terminal to perform channel measurement and report or interference measurement and report on a target resource; and the first indication information indicates at least one of the following:
configuration information corresponding to the target resource; or
a transmission format of the target resource.

14. The method according to claim 13, wherein the first indication information is carried in at least one of the following:
radio resource control (RRC) information;
group-common downlink control information (DCI);
a medium access control (MAC) control element (CE); or
uplink transmission scheduled by using DCI, or downlink transmission scheduled by using DCI.

15. The method according to claim 13, wherein
the configuration information corresponding to the target resource is used to configure at least one resource set, wherein
each resource set comprises at least one resource; and
the each resource set comprises at least one of the following:
a time domain resource;
a frequency domain resource;
a transmission format of a resource in the resource set;
a CSI-RS resource configuration corresponding to the resource set;
a CSI reporting type corresponding to the resource set;
a frequency domain interval between the resource set and at least one frequency domain resource unit in a transmission format of uplink; or
a frequency domain interval between the resource set and at least one frequency domain resource unit in a transmission format of flexible.

16. The method according to claim 13, wherein the first indication information indicates at least one of the following:
at least one CSI reporting trigger instruction; or
at least one reporting mode; wherein
each CSI reporting trigger instruction comprises at least one of the following:
one or more of CSI-RS resource configurations;
a CSI reporting type corresponding to one or more of the CSI-RS resource configurations;
a resource set corresponding to one or more of the CSI-RS resource configurations;
a frequency domain interval between a downlink resource unit to which one or more of the CSI-RS resource configurations are applicable and at least one frequency domain resource unit in a transmission format of uplink; or
a frequency domain interval between a downlink resource unit to which one or more of the CSI-RS resource configurations are applicable and at least one frequency domain resource unit in a transmission format of Flexible;
or,
the reporting mode comprises at least one of the following:
a measurement reporting mode corresponding to the first CSI-RS resource configuration;
a measurement reporting mode corresponding to the second CSI-RS resource configuration;
or a measurement reporting mode corresponding to the third CSI-RS resource configuration.

17. The method according to claim 12, wherein the first resource meets any one of the following that:
a frequency domain resource unit of the first resource does not overlap with any frequency domain resource unit in a transmission format of uplink or flexible;
a frequency domain interval between a frequency domain resource unit of the first resource and a frequency domain resource unit in a transmission format of uplink or flexible is greater than or equal to N first frequency domain resource units; and
a frequency domain interval between a center frequency of the first resource and a center frequency of a frequency domain resource unit in a transmission format of uplink or flexible is greater than or equal to M second frequency domain resource units, wherein N and M are positive integers;
or,
the second resource meets at least one of the following that:
a frequency domain resource unit of the second resource overlaps with a frequency domain resource unit in a transmission format of uplink or flexible;
a frequency domain resource unit of the second resource does not overlap with a frequency domain resource unit in a transmission format of uplink or flexible, and a frequency domain interval between the frequency domain resource unit of the second resource and the frequency domain resource unit in the transmission format of uplink or flexible is less than or equal to X third frequency domain resource units; or
a frequency domain resource unit of the second resource does not overlap with a frequency domain resource unit in a transmission format of uplink or flexible, and a frequency domain interval between a center frequency of the second resource and a center frequency of the frequency domain resource unit in the transmission format of uplink or flexible is less than or equal to Y fourth frequency domain resource units, wherein
X and Y are positive integers;
or,
the third resource meets at least one of the following that:
a frequency domain resource unit of the third resource overlaps with a frequency domain resource unit in a transmission format of uplink or flexible;
a frequency domain resource unit of the third resource does not overlap with a frequency domain resource unit in a transmission format of uplink or flexible, and a frequency domain interval between the frequency domain resource unit of the third resource and the frequency domain resource unit in the transmission format of uplink or flexible is less than or equal to X frequency domain resource units; or
a frequency domain resource unit of the third resource does not overlap with a frequency domain resource unit in a transmission format of uplink or flexible, and a frequency domain interval between a center frequency of the third resource and a center frequency of the frequency domain resource unit in the transmission format of uplink or flexible is less than or equal to Y frequency domain resource units, wherein
X and Y are positive integers.

18. The method according to claim 12, wherein the one or more pieces of CSI-RS resource configuration information are used to configure at least one of the following:
a periodic or semi-persistent CSI-RS resource;
an aperiodic CSI-RS resource;
periodic or semi-persistent CSI reporting; or
aperiodic CSI reporting.

19. A terminal, comprising a processor and a memory, wherein the memory stores a program or an instruction executable on the processor, and the program or the instruction, when executed by the processor, causes the terminal to perform:
receiving one or more pieces of channel state information reference signal (CSI-RS) resource configuration information sent by a network side device; and
performing channel measurement and report or interference measurement and report on a target resource based on the one or more pieces of CSI-RS resource configuration information, wherein
the CSI-RS resource configuration information is used to configure at least one of the following:
at least one first CSI-RS resource configuration;
at least one second CSI-RS resource configuration; or
at least one third CSI-RS resource configuration;
the first CSI-RS resource configuration is used for a first resource;
the second CSI-RS resource configuration is used for a second resource; and
the third CSI-RS resource configuration is used for a third resource.

20. A network side device, comprising a processor and a memory, wherein the memory stores a program or an instruction executable on the processor, and when the program or the instruction is executed by the processor, steps of the resource configuration method according to claim 12 are implemented.
